(19) United States
(12) Patent Application Publication
(10) Pub. No.: US 2025/0240812 A1
(43) Pub. Date: Jul. 24, 2025

(54) COORDINATED ACCESS TO AN UNLICENSED SPECTRUM

(71) Applicant: QUALCOMM Incorporated, San Diego, CA (US)

(72) Inventors: Chih-Hao LIU, San Diego, CA (US); Jing SUN, San Diego, CA (US); Yisheng XUE, San Diego, CA (US); Peter GAAL, San Diego, CA (US); Giovanni CHISCI, San Diego, CA (US); Luanxia YANG, Beijing (CN); Xiaoxia ZHANG, San Diego, CA (US); Aleksandar DAMNJANOVIC, Del Mar, CA (US)

(21) Appl. No.: 18/855,504

(22) PCT Filed: Jun. 9, 2022
(86) PCT No.: PCT/CN2022/097810

§ 371 Date: Oct. 9, 2024

(51) Int. Cl. H04W 74/00; H04W 74/0808; H04W 92/18

(52) U.S. Cl. CPC H04W 74/002; H04W 74/0808; H04W 92/18

(57) ABSTRACT

Various aspects of the present disclosure generally relate to wireless communication. In some aspects, a user equipment (UE) may transmit an indication of a resource reservation associated with an unlicensed spectrum, the indication specifying at least a listen-before-talk (LBT) parameter associated with category 4 (CAT 4) access to the unlicensed spectrum and an interlace index associated with a resource in the unlicensed spectrum assigned to a participating UE associated with coordinated access to the unlicensed spectrum. The UE may communicate in a wireless network based at least in part on the resource reservation associated with the unlicensed spectrum, the LBT parameter, and the interlace index. Numerous other aspects are described.

### FIELD OF THE DISCLOSURE

Aspects of the present disclosure generally relate to wireless communication and to techniques and apparatuses for coordinated access to an unlicensed spectrum.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a UE. The method may include transmitting an indication of a resource reservation associated with an unlicensed spectrum, the indication specifying at least a listen-before-talk (LBT) parameter associated with category 4 (CAT 4) access to the unlicensed spectrum and an interlace index associated with a resource in the unlicensed spectrum assigned to a participating UE associated with coordinated access to the unlicensed spectrum. The method may include communicating in a wireless network based at least in part on the resource reservation associated with the unlicensed spectrum, the LBT parameter, and the interlace index.

Some aspects described herein relate to a method of wireless communication performed by a UE. The method may include receiving an indication of a resource reservation associated with an unlicensed spectrum, the indication specifying at least an LBT parameter associated with a channel access procedure to the unlicensed spectrum and an interlace index associated with a resource in the unlicensed spectrum assigned to the UE, the indication associated with coordinated access to the unlicensed spectrum. The method may include communicating in a wireless network based at least in part on the resource reservation associated with the unlicensed spectrum, the LBT parameter, and the interlace index.

Some aspects described herein relate to an apparatus for wireless communication at a UE. The apparatus may include a memory and one or more processors coupled to the memory. The one or more processors may be configured to transmit an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to a participating UE associated with coordinated access to the unlicensed spectrum. The one or more processors may be configured to communicate in a wireless network based at least in part on the resource reservation associated with the unlicensed spectrum, the LBT parameter, and the interlace index.

Some aspects described herein relate to an apparatus for wireless communication at a UE. The apparatus may include a memory and one or more processors coupled to the memory. The one or more processors may be configured to receive an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to the UE, the indication associated with coordinated access to the unlicensed spectrum. The one or more processors may be configured to communicate in a wireless network based at least in part on the resource reservation associated with the unlicensed spectrum, the LBT parameter, and the interlace index.

Some aspects described herein relate to a non-transitory computer-readable medium that stores a set of instructions for wireless communication by a UE. The set of instructions, when executed by one or more processors of the UE, may cause the UE to transmit an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to a participating UE associated with coordinated access to the unlicensed spectrum. The set of instructions, when executed by one or more processors of the UE, may cause the UE to communicate in a wireless network based at least in part on the resource reservation associated with the unlicensed spectrum, the LBT parameter, and the interlace index.

Some aspects described herein relate to a non-transitory computer-readable medium that stores a set of instructions for wireless communication by a one or more instructions that, when executed by one or more processors of an UE, may cause the UE to receive an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to the UE, the indication associated with coordinated access to the unlicensed spectrum. The set of instructions, when executed by one or more processors of the UE, may cause the UE to communicate in a wireless network based at least in part on the resource reservation associated with the unlicensed spectrum, the LBT parameter, and the interlace index.

Some aspects described herein relate to an apparatus for wireless communication. The apparatus may include means for transmitting an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to a participating UE associated with coordinated access to the unlicensed spectrum. The apparatus may include means for communicating in a wireless network based at least in part on the resource reservation associated with the unlicensed spectrum, the LBT parameter, and the interlace index.

Some aspects described herein relate to an apparatus for wireless communication. The apparatus may include means for receiving an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to the apparatus, the indication associated with coordinated access to the unlicensed spectrum. The apparatus may include means for communicating in a wireless network based at least in part on the resource reservation associated with the unlicensed spectrum, the LBT parameter, and the interlace index.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating an example of sidelink communications, in accordance with the present disclosure.

FIG. 4 is a diagram illustrating an example of sidelink communications and access link communications, in accordance with the present disclosure.

FIG. 5 is a diagram illustrating an example of sidelink communications that are based at least in part on accessing an unlicensed spectrum, in accordance with the present disclosure.

FIG. 6 is a diagram illustrating an example of coordinated channel access to unlicensed spectrum for sidelink communications, in accordance with the present disclosure.

FIG. 7 illustrates an example of a wireless communication process between a first UE, a second UE, and a third UE in a wireless communication network, in accordance with the present disclosure.

FIG. 8 is a diagram illustrating an example process performed, for example, by a UE, in accordance with the present disclosure.

FIG. 9 is a diagram illustrating another example process performed, for example, by a UE, in accordance with the present disclosure.

FIG. 10 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

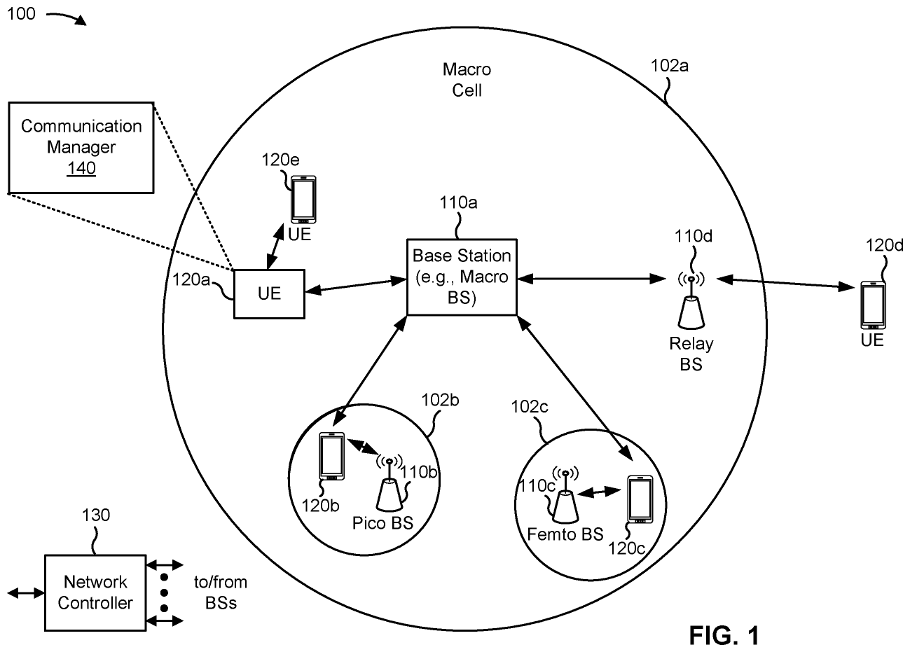

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, a base station, or a network equipment may be implemented in an aggregated or disaggregated architecture. For example, a base station (such as a Node B (NB), evolved NB (eNB), NR base station (BS), 5G NB, gNodeB (gNB), access point (AP), transmit receive point (TRP), or cell), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station may be configured to utilize a radio protocol stack that is physically or logically integrated within a single RAN node (for example, within a single device or unit). A disaggregated base station may be configured to utilize a protocol stack that is physically or logically distributed among two or more units (such as one or more CUs, one or more DUs, or one or more RUs). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also may be implemented as virtual units (e.g., a virtual central unit (VCU), a virtual distributed unit (VDU), or a virtual radio unit (VRU)).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that may be individually deployed. A disaggregated base station may include functionality implemented across two or more units at various physical locations, as well as functionality implemented for at least one unit virtually, which may enable flexibility in network design. The various units of the disaggregated base station may be configured for wired or wireless communication with at least one other unit of the disaggregated base station.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may transmit an indication of a resource reservation associated with an unlicensed spectrum, the indication specifying at least an LBT parameter associated with a channel access procedure for accessing the unlicensed spectrum (e.g., LBT access) and an interlace index associated with a resource in the unlicensed spectrum assigned to a participating UE associated with coordinated access to the unlicensed spectrum; and communicate in a wireless network based at least in part on the resource reservation associated with the unlicensed spectrum, the LBT parameter, and the interlace index. Additionally, or alternatively, the communication manager 140 may perform one or more other operations described herein.

Alternatively or additionally, the communication manager 140 may receive an indication of a resource reservation associated with an unlicensed spectrum, the indication specifying at least an LBT parameter associated with a channel access procedure for accessing the unlicensed spectrum (e.g., LBT access) and an interlace index associated with a resource in the unlicensed spectrum assigned to the UE, the indication associated with coordinated access to the unlicensed spectrum; and communicate in a wireless network based at least in part on the resource reservation associated with the unlicensed spectrum, the LBT parameter, and the interlace index. Additionally, or alternatively, the communication manager 140 may perform one or more other operations described herein.

As indicated above, FIG. 1 is provided as an example. Other examples may differ from what is described with regard to FIG. 1.

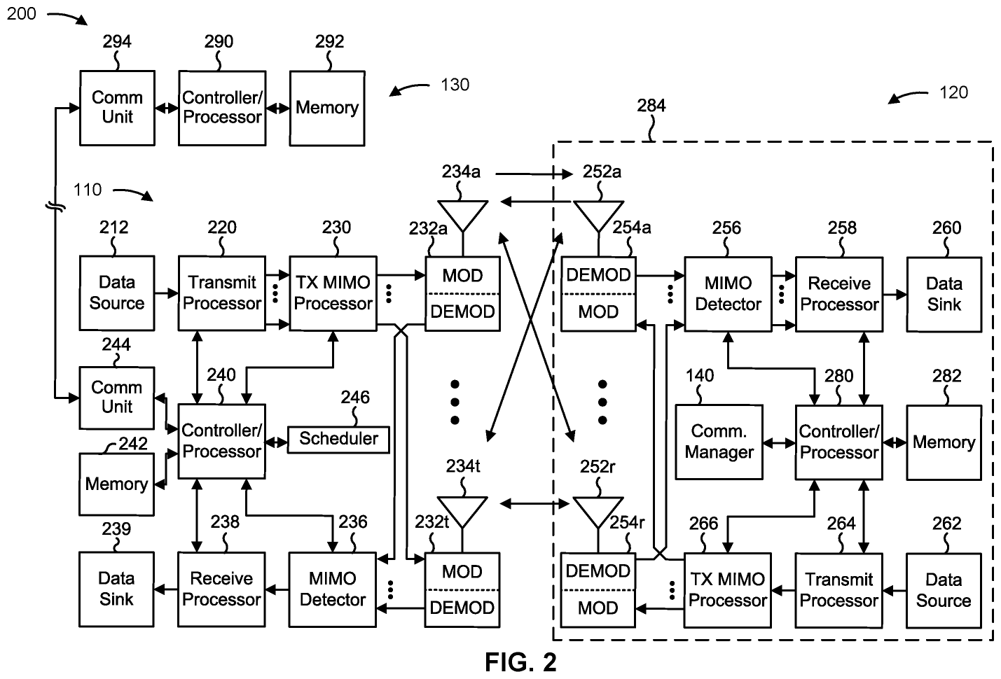

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

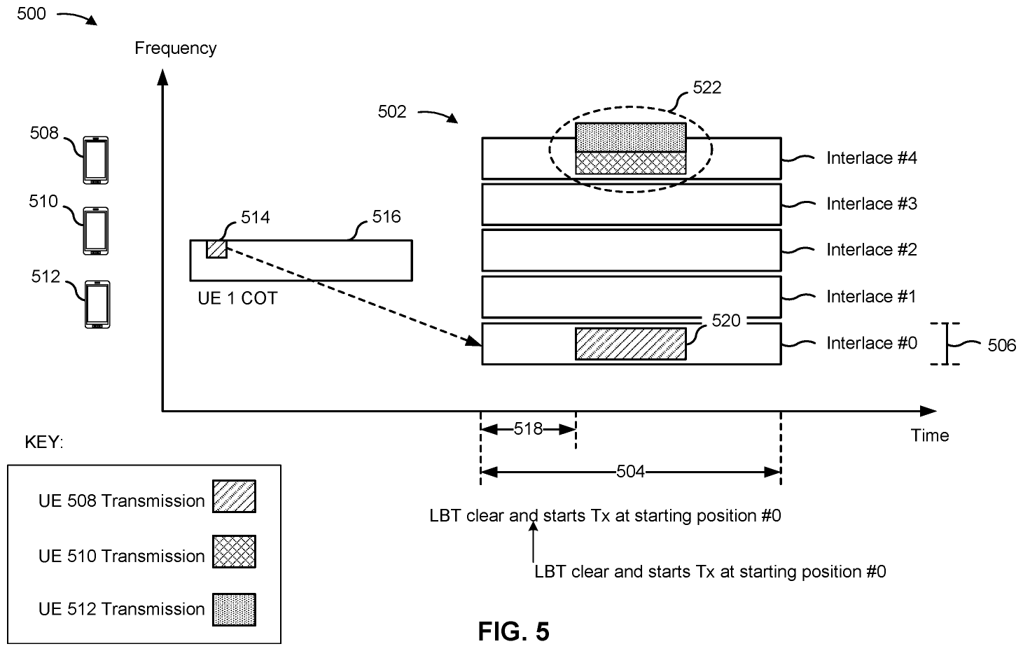

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 5-10).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 5-10).

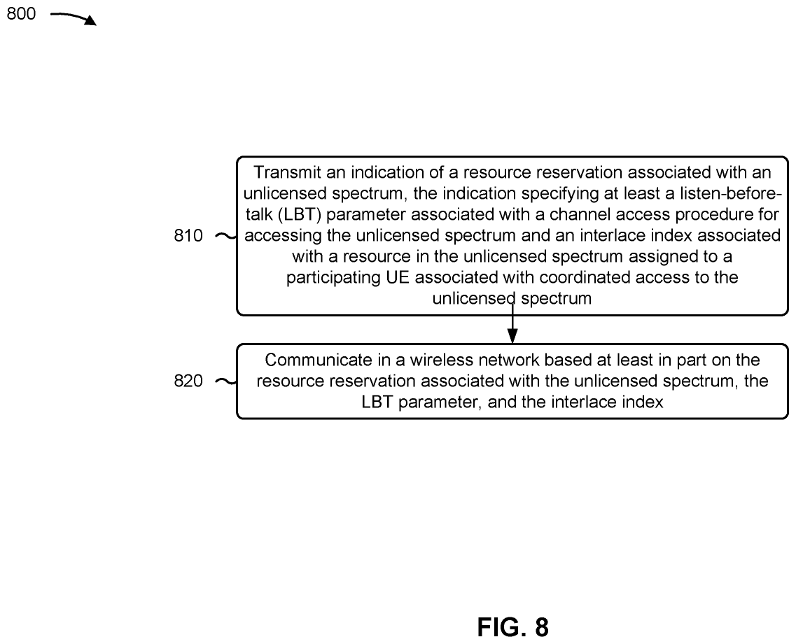

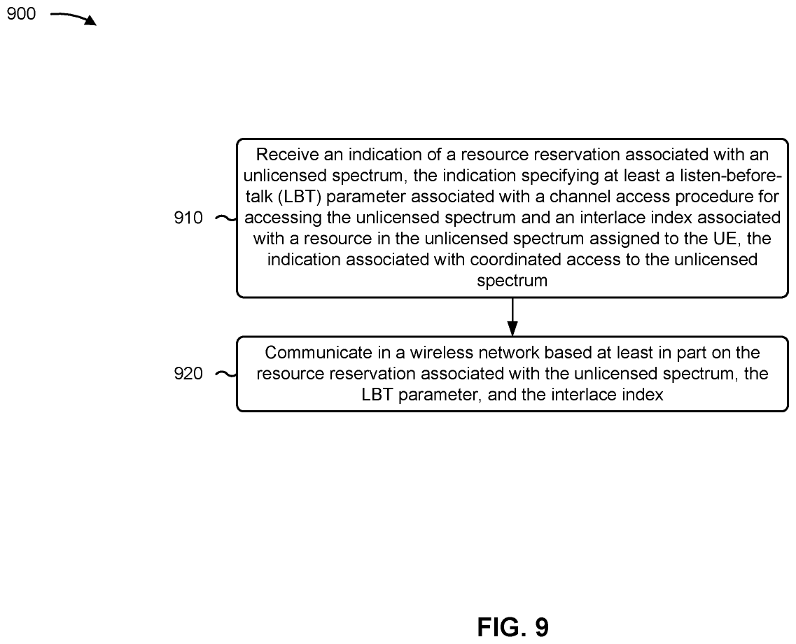

The controller/processor 240 of the base station 110, the controller/processor 280 of the UE 120, and/or any other component(s) of FIG. 2 may perform one or more techniques associated with coordinated access to an unlicensed spectrum, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for transmitting an indication of a resource reservation associated with an unlicensed spectrum, the indication specifying at least an LBT parameter associated with a channel access procedure for accessing the unlicensed spectrum (e.g., LBT access) and an interlace index associated with a resource in the unlicensed spectrum assigned to a participating UE associated with coordinated access to the unlicensed spectrum; and/or means for communicating in a wireless network based at least in part on the resource reservation associated with the unlicensed spectrum, the LBT parameter, and the interlace index. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the UE includes means for receiving an indication of a resource reservation associated with an unlicensed spectrum, the indication specifying at least an LBT parameter associated with a channel access procedure for accessing the unlicensed spectrum (e.g., LBT access) and an interlace index associated with a resource in the unlicensed spectrum assigned to the UE, the indication associated with coordinated access to the unlicensed spectrum; and/or means for communicating in a wireless network based at least in part on the resource reservation associated with the unlicensed spectrum, the LBT parameter, and the interlace index. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

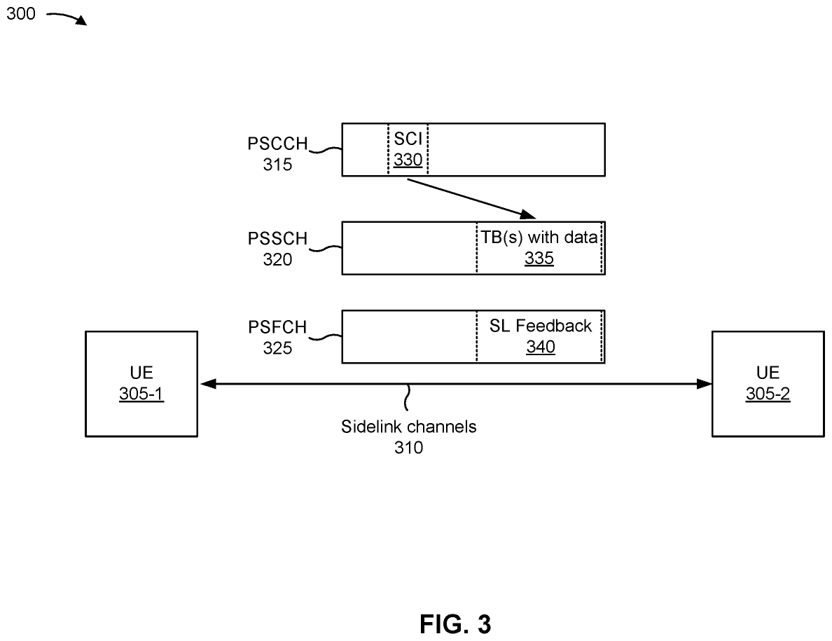

FIG. 3 is a diagram illustrating an example 300 of sidelink communications, in accordance with the present disclosure.

As shown in FIG. 3, a first UE 305-1 may communicate with a second UE 305-2 (and one or more other UEs 305) via one or more sidelink channels 310. The UEs 305-1 and 305-2 may communicate using the one or more sidelink channels 310 for P2P communications, D2D communications, V2X communications (e.g., which may include V2V communications, V2I communications, and/or V2P communications) and/or mesh networking. In some aspects, the UEs 305 (e.g., UE 305-1 and/or UE 305-2) may correspond to one or more other UEs described elsewhere herein, such as UE 120. In some aspects, the one or more sidelink channels 310 may use a PC5 interface and/or may operate in a high frequency band (e.g., the 5.9 GHz band). Additionally, or alternatively, the UEs 305 may synchronize timing of transmission time intervals (TTIs) (e.g., frames, subframes, slots, or symbols) using global navigation satellite system (GNSS) timing.

As further shown in FIG. 3, the one or more sidelink channels 310 may include a physical sidelink control channel (PSCCH) 315, a physical sidelink shared channel (PSSCH) 320, and/or a physical sidelink feedback channel (PSFCH) 325. The PSCCH 315 may be used to communicate control information, similar to a physical downlink control channel (PDCCH) and/or a physical uplink control channel (PUCCH) used for cellular communications with a base station 110 via an access link or an access channel. The PSSCH 320 may be used to communicate data, similar to a physical downlink shared channel (PDSCH) and/or a physical uplink shared channel (PUSCH) used for cellular communications with a base station 110 via an access link or an access channel. For example, the PSCCH 315 may carry sidelink control information (SCI) 330, which may indicate various control information used for sidelink communications, such as one or more resources (e.g., time resources, frequency resources, and/or spatial resources) where a transport block (TB) 335 may be carried on the PSSCH 320. The TB 335 may include data. The PSFCH 325 may be used to communicate sidelink feedback 340, such as hybrid automatic repeat request (HARQ) feedback (e.g., acknowledgement or negative acknowledgement (ACK/NACK) information), transmit power control (TPC), and/or a scheduling request (SR).

Although shown on the PSCCH 315, in some aspects, the SCI 330 may include multiple communications in different stages, such as a first stage SCI (SCI-1) and a second stage SCI (SCI-2). The SCI-1 may be transmitted on the PSCCH 315. The SCI-2 may be transmitted on the PSSCH 320. The SCI-1 may include, for example, an indication of one or more resources (e.g., time resources, frequency resources, and/or spatial resources) on the PSSCH 320, information for decoding sidelink communications on the PSSCH, a quality of service (QOS) priority value, a resource reservation period, a PSSCH demodulation reference signal (DMRS) pattern, an SCI format for the SCI-2, a beta offset for the SCI-2, a quantity of PSSCH DMRS ports, and/or a modulation and coding scheme (MCS). The SCI-2 may include information associated with data transmissions on the PSSCH 320, such as a hybrid automatic repeat request (HARQ) process ID, a new data indicator (NDI), a source identifier, a destination identifier, and/or a channel state information (CSI) report trigger.

In some aspects, the one or more sidelink channels 310 may use resource pools. For example, a scheduling assignment (e.g., included in SCI 330) may be transmitted in sub-channels using specific resource blocks (RBs) across time. In some aspects, data transmissions (e.g., on the PSSCH 320) associated with a scheduling assignment may occupy adjacent RBs in the same subframe as the scheduling assignment (e.g., using frequency division multiplexing). In some aspects, a scheduling assignment and associated data transmissions are not transmitted on adjacent RBs.

In some aspects, a UE 305 may operate using a sidelink transmission mode (e.g., Mode 1) where resource selection and/or scheduling is performed by a base station 110. For example, the UE 305 may receive a grant (e.g., in downlink control information (DCI) or in a radio resource control (RRC) message, such as for configured grants) from the base station 110 for sidelink channel access and/or scheduling. In some aspects, a UE 305 may operate using a transmission mode (e.g., Mode 2) where resource selection and/or scheduling is performed by the UE 305 (e.g., rather than a base station 110). In some aspects, the UE 305 may perform resource selection and/or scheduling by sensing channel availability for transmissions. For example, the UE 305 may measure a received signal strength indicator (RSSI) parameter (e.g., a sidelink-RSSI (S-RSSI) parameter) associated with various sidelink channels, may measure a reference signal received power (RSRP) parameter (e.g., a PSSCH-RSRP parameter) associated with various sidelink channels, and/or may measure a reference signal received quality (RSRQ) parameter (e.g., a PSSCH-RSRQ parameter) associated with various sidelink channels, and may select a channel for transmission of a sidelink communication based at least in part on the measurement(s).

Additionally, or alternatively, the UE 305 may perform resource selection and/or scheduling using SCI 330 received in the PSCCH 315, which may indicate occupied resources and/or channel parameters. Additionally, or alternatively, the UE 305 may perform resource selection and/or scheduling by determining a channel busy ratio (CBR) associated with various sidelink channels, which may be used for rate control (e.g., by indicating a maximum number of resource blocks that the UE 305 can use for a particular set of subframes).

In the transmission mode where resource selection and/or scheduling is performed by a UE 305, the UE 305 may generate sidelink grants, and may transmit the grants in SCI 330. A sidelink grant may indicate, for example, one or more parameters (e.g., transmission parameters) to be used for an upcoming sidelink transmission, such as one or more resource blocks to be used for the upcoming sidelink transmission on the PSSCH 320 (e.g., for TBs 335), one or more subframes to be used for the upcoming sidelink transmission, and/or a modulation and coding scheme (MCS) to be used for the upcoming sidelink transmission. In some aspects, a UE 305 may generate a sidelink grant that indicates one or more parameters for semi-persistent scheduling (SPS), such as a periodicity of a sidelink transmission. Additionally, or alternatively, the UE 305 may generate a sidelink grant for event-driven scheduling, such as for an on-demand sidelink message.

As indicated above, FIG. 3 is provided as an example. Other examples may differ from what is described with respect to FIG. 3.

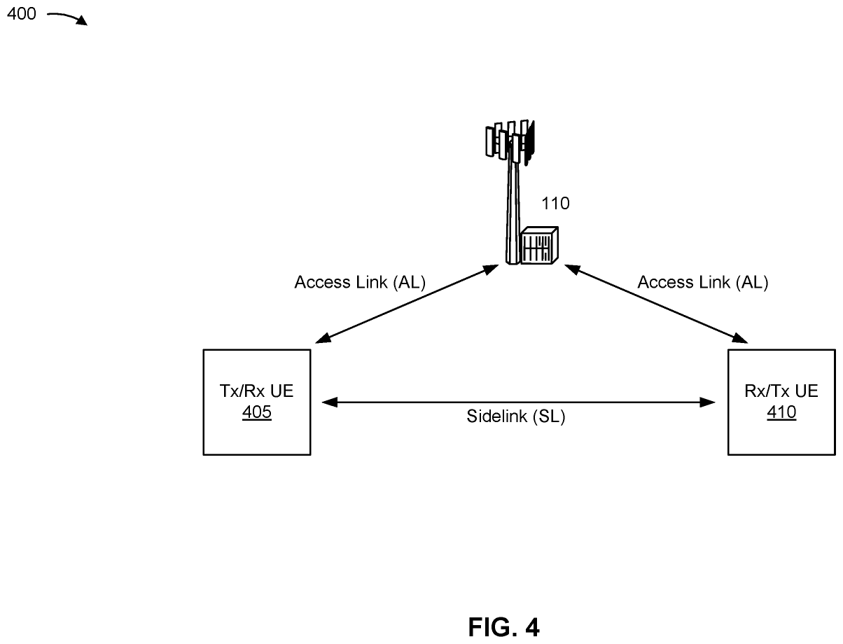

FIG. 4 is a diagram illustrating an example 400 of sidelink communications and access link communications, in accordance with the present disclosure.

As shown in FIG. 4, a transmitter (Tx)/receiver (Rx) UE 405 and an Rx/Tx UE 410 may communicate with one another via a sidelink, as described above in connection with FIG. 3. As further shown, in some sidelink modes, a base station 110 may communicate with the Tx/Rx UE 405 via a first access link. Additionally, or alternatively, in some sidelink modes, the base station 110 may communicate with the Rx/Tx UE 410 via a second access link. The Tx/Rx UE 405 and/or the Rx/Tx UE 410 may correspond to one or more UEs described elsewhere herein, such as the UE 120 of FIG. 1. Thus, a direct link between UEs 120 (e.g., via a PC5 interface) may be referred to as a sidelink, and a direct link between a base station 110 and a UE 120 (e.g., via a Uu interface) may be referred to as an access link. Sidelink communications may be transmitted via the sidelink, and access link communications may be transmitted via the access link. An access link communication may be either a downlink communication (from a base station 110 to a UE 120) or an uplink communication (from a UE 120 to a base station 110).

As indicated above, FIG. 4 is provided as an example. Other examples may differ from what is described with respect to FIG. 4.

FIG. 5 is a diagram illustrating an example 500 of sidelink communications that are based at least in part on accessing an unlicensed spectrum, in accordance with the present disclosure.

In some aspects, a UE may perform an LBT procedure and/or a clear channel assessment (CCA) to gain access to a frequency band and/or wireless channel that is based at least in part on a portion of unlicensed spectrum. “Unlicensed spectrum” may denote frequency spectrum that may be utilized by any device without exclusive access (e.g., a portion of frequency that may be accessed without a license). “LBT procedure” may denote an operation and/or procedure that determines whether a signal occupies a wireless channel and/or frequency band (or whether the wireless channel is clear of an occupying signal). As one example, an LBT procedure may determine a presence or absence of energy in a wireless channel. The phrase “LBT clearing” or similar phrases may denote that an LBT procedure determines that there is an absence of energy in a wireless channel and/or that the wireless channel is clear for use. Accordingly, when an LBT procedure determines the wireless channel is clear for use, a UE may gain access to unlicensed spectrum for a length of time referred to as a channel occupancy time (COT). In some aspects, the length of time associated with a COT may be characterized and/or partitioned into smaller time durations, such as multiple time slots. During the COT, the UE can perform uplink transmissions without performing additional LBT procedures.

As shown in FIG. 5, an example COT structure 502 associated with unlicensed spectrum may be based at least in part on one or more resources that may be characterized, at least in part, by a time duration 504 (e.g., shown on a horizonal axis that represents time). Each resource of the COT structure 502 may be associated with a respective frequency span (e.g., shown on a vertical axis that represents frequency) such that the COT structure 502 may include multiple resources that are associated with different frequency spans for the time duration 504. A COT resource may alternatively or additionally be referred to as an “interlace.” With regard to the COT structure 502, a first resource labeled as interlace #0 may be based at least in part on the time duration 504 and a first frequency span 506. A second resource allocation labeled as interlace #1 may be based at least in part on the time duration 504 and a second frequency span that is different from the first frequency span 506. Similarly, a third resource labeled as interlace #2, a fourth resource labeled as interlace #3, and a fifth resource labeled as interlace #4 may each be based at least in part on the time duration 504 and respective frequency spans. In some aspects, the frequency span associated with an interlace may be characterized and/or partitioned into smaller frequency spans (e.g., sub-bands). The appended numbers 0-4 may refer to an interlace index such that a particular interlace may be identified based at least in part on a respective interlace index. While the COT structure 502 of the example 500 includes five interlaces, other examples may include more or fewer interlaces that are contiguous in frequency, are equally spaced from one another in frequency, and/or are equally separated from one another in frequency. A COT structure that is based at least in part on frequency division multiplexing (FDM), such as the COT structure 502, may enable multiple devices to transmit during a same COT based at least in part on using a different frequency span (and interlace) relative to other devices.

The time duration of the COT may be dependent on a type of LBT procedure and one or more LBT parameters associated with the LBT procedure. Example categories of LBT procedures may include category one (CAT 1) LBT, category two (CAT 2) LBT, category three (CAT 3) LBT, and category four (CAT 4) LBT. In CAT 1 LBT, also referred to as no LBT, an LBT procedure is not performed prior to transmission of a communication on the channel. In CAT 2 LBT, a time duration associated with channel sensing is fixed (e.g., without random back-off). In some aspects, “channel sensing” may denote determining if the channel is clear over the time duration, which may also be referred to as a contention window. For example, a fixed (channel sensing) time duration of 16 microseconds is used for 16 microsecond CAT 2 LBT, and a fixed (channel sensing) time duration of 25 microseconds is used for 25 microsecond CAT 2 LBT. In CAT 3 LBT, the channel sensing time duration is fixed (e.g., the contention window has a fixed size), and random back-off is used. In CAT 4 LBT, the channel sensing time duration is variable (e.g., the contention window has a variable size), and random back-off is used.

In CAT 4 LBT, the channel sensing time duration may be variable depending on whether the device contending for access to the channel senses interference (e.g., an energy level greater than or equal to a threshold). Using a CAT 4 LBT procedure, the device may select a minimum channel sensing time duration, which may be defined by a channel access priority class (CAPC) associated with the CAT 4 LBT procedure being used by the device. For example, four different CAPCs may be associated with CAT 4 LBT, with the lowest CAPC value (e.g., CAPC 0) being associated with the highest priority for CAT 4 LBT (e.g., the shortest contention window size and shortest back-off duration), and the highest CAPC value (e.g., CAPC 3) being associated with the lowest priority for CAT 4 LBT (e.g., the longest contention window size and longest back-off duration). In some aspects, a higher CAPC value (e.g., a higher CAPC index) is associated with a lower priority. In CAT 4 LBT, if the device detects interference in the minimum channel sensing duration for a CCA procedure as defined by a CAPC for the CAT 4 LBT procedure, then the device may increase the channel sensing duration for the next CCA procedure.

In some aspects, a UE may select and reserve an interlace that occurs in a future COT for a sidelink transmission and indicate the selection and/or reservation to other UEs. As an example, a first UE 508 may select an interlace based at least in part on identifying that an associated data buffer includes data for transmission. In the example 500, the first UE 508 selects the interlace #0 associated with the COT structure 502. Based at least in part on selecting an interlace associated with a future COT, the first UE 508 may indicate the reservation to other UEs (shown as a second UE 510 and a third UE 512). To illustrate, the first UE 508 may transmit an indication as shown by reference number 514, where the indication specifies the reservation of the interlace #0 associated with the COT structure 502. Transmissions associated with the first UE 508 are shown in the example 500 through the use of a diagonal line hash pattern.

In one example, the first UE 508 may transmit the indication in groupcast SCI (e.g., in a COT resource 516 associated with a prior time duration relative to the time duration 504). A “groupcast” transmission, such as a transmission associated with groupcast SCI, may denote a one-to-many transmission in which a single device (e.g., the first UE 508) transmits information that may be received and recovered by multiple devices, such as the UE 510 and the UE 512. At a starting time associated with the time duration 504, the first UE 508 may perform an LBT procedure (e.g., a CAT 4 LBT procedure) based at least in part on a contention window 518 associated with the COT structure 502, and transmit information using the interlace #0 as shown by reference number 520.

In a similar manner as the first UE 508, the second UE 510 and the third UE 512 may each determine to transmit information using a resource associated with the COT structure 502. Based at least in part on receiving the indication transmitted by the first UE 508, the second UE 510 and the third UE 512 may each refrain from selecting the interlace #0 for transmitting the respective information. However, refraining from selecting the interlace #0 may result in the second UE 510 and the third UE 512 selecting a same resource associated with the COT structure 502, such as the interlace #4. In some aspects, the second UE 510 and/or the third UE 512 may transmit an indication that specifies a reservation of the interlace #4, but the other UE may fail to receive and process the indication before a start of the time duration 504 and/or the contention window 518. Accordingly, each UE may perform an LBT procedure and, after LBT clearing, the second UE 510 and the third UE 512 may each transmit information using the interlace #4 such that the two transmissions collide with one another as shown by reference number 522. Transmissions by the second UE 510 are shown through the use of a cross-line hash pattern and transmissions by the third UE 512 are shown through the use of a dotted hash pattern. The collision may increase recovery failures and/or errors at a receiver, reduce a data throughput in sideline communications, and/or consume additional resources (e.g., with retransmissions).

Some techniques and apparatuses described herein provide coordinated LBT channel access to an unlicensed spectrum. In some aspects, a UE (e.g., acting as a coordinating UE) may transmit an indication of a resource reservation associated with an unlicensed spectrum. As one example, the indication may specify at least an LBT parameter associated with a channel access procedure for accessing the unlicensed spectrum (e.g., LBT access) and an interlace index associated with a resource in the unlicensed spectrum assigned to a participating UE. The participating UE may be associated with coordinated access to the unlicensed spectrum that is managed, at least in part, by the UE acting as the coordinating UE. Based at least in part on transmitting the indication, the UE may communicate in a wireless network based at least in part on the resource reservation associated with the unlicensed spectrum, the LBT parameter, and the interlace index. As one example, the UE may transmit in a first resource assigned to the UE and/or refrain from transmitting in a second resource assigned to another UE.

In some aspects, a UE (e.g., acting as a participating UE) may receive an indication of a resource reservation associated with an unlicensed spectrum. The indication may also specify at least an LBT parameter associated with CAT 4 access (e.g., LBT access) to the unlicensed spectrum and an interlace index associated with a resource in the unlicensed spectrum assigned to the UE. The indication received by the UE may be associated with coordinated access to the unlicensed spectrum that is managed, at least in part, by a coordinating UE that is different from the receiving UE. Based at least in part on receiving the indication, the UE may communicate in a wireless network based at least in part on the resource reservation associated with the unlicensed spectrum, the LBT parameter, and the interlace index. As one example, the UE may transmit in a first resource assigned to the UE and/or refrain from transmitting in a second resource assigned to another UE.

By coordinating LBT channel access to an unlicensed spectrum, a coordinating UE may mitigate other UEs operating within a distance threshold of one another selecting a same resource (e.g., an interlace associated with a COT) and mitigate transmission collisions, such as collisions in sidelink communications. Mitigating transmission collisions may improve the sidelink communications by reducing recovery failures and/or errors at a receiver, increasing data throughput, and/or reducing resource consumption.

As indicated above, FIG. 5 is provided as an example. Other examples may differ from what is described with respect to FIG. 5.

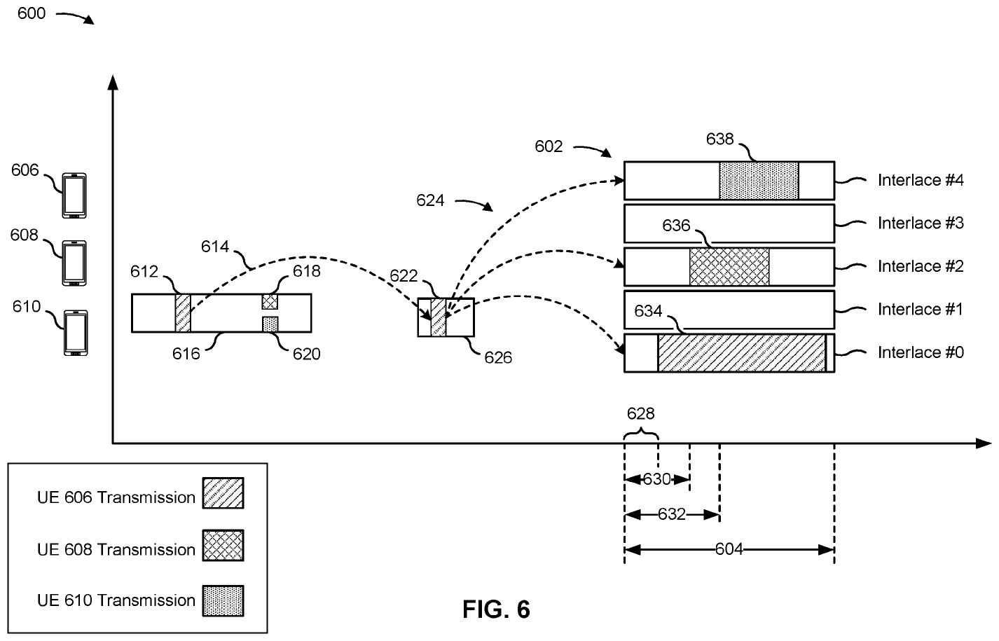

FIG. 6 is a diagram illustrating an example 600 of coordinated LBT channel access for sidelink communications, in accordance with the present disclosure.

In a manner similar to that described with regard to the example 500, the example 600 includes a COT structure 602 that includes multiple resources (e.g., an interlace #0, an interlace #1, an interlace #2, an interlace #3, and an interlace #4) associated with accessing an unlicensed spectrum. The resources may be defined by a time duration 604, shown on a horizontal axis that represents time, and one or more frequency spans, shown on a vertical axis that represents frequency.

As further described below, the example 600 also shows transmissions that may be associated with one or more UEs in a set of UEs (e.g., a first UE 606, a second UE 608, and/or a third UE 610). The inclusion of each UE in the set may be based at least in part on each UE operating at a location that satisfies a distance threshold relative to one another. Alternatively or additionally, the set of UEs may be based at least in part on each UE selecting to participate in the coordinated access to the unlicensed spectrum. Transmissions by the first UE 606, the second UE 608, and third UE 610 are shown through the use of a diagonal line hash pattern, a cross-line hash pattern, and a dotted hash pattern, respectively.

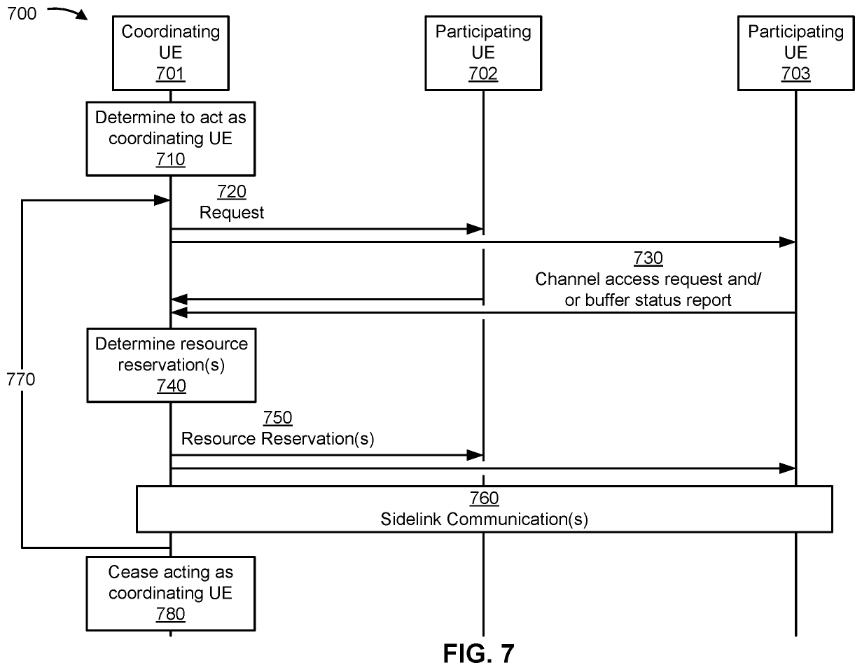

In some aspects, the first UE 606 may act as a coordinating UE for the set of UEs participating in coordinated access to the unlicensed spectrum. As one example, the first UE 606 may receive an instruction from a network entity (e.g., a base station 110) to act as the coordinating UE for sidelink communications. As another example, the first UE 606 may determine to act as the coordinating UE, as further described with regard to FIG. 7.

As shown by reference number 612 and, based at least in part on the first UE 606 acting as a coordinating UE, the first UE 606 may transmit a request and/or pulling SCI (e.g., SCI configured to pull information from a receiving device) for information from one or more UEs that may be within transmitting and/or receiving distance of the coordinating UE. As one example, the first UE 606 may transmit a pulling SCI and/or a request (e.g., via the SCI) for a channel access request (CAR) and/or a buffer status report (BSR) from the UE(s), where a CAR and/or BSR may be used by a UE to indicate that the UE has pending information to transmit. The first UE 606 may transmit the pulling SCI as a groupcast SCI to one or more UEs (e.g., within the set of UEs and/or external to the set of UEs). However, in other examples, the first UE 606 may refrain from transmitting the request and/or pulling SCI. To illustrate, the first UE 606 may monitor SCI for periodic and/or an autonomous CAR and/or BSR associated with sidelink communications without transmitting the pulling SCI. In some aspects, the pulling SCI may be transmitted and/or configured as SCI-1.

As shown by reference number 614, the first UE 606 may transmit, in the pulling SCI, an indication of a first resource reservation for the first UE 606. For example, the first UE 606 may transmit the indication of the first resource reservation to indicate that the first UE 606 may communicate one or more resource reservations and/or assignments associated with coordinated access to an unlicensed spectrum based at least in part on the indicated resource reservation. In some aspects, the first UE 606 may include, in the indication, a groupcast identifier (ID) that may be associated with the coordinated access to the unlicensed spectrum, a UE managing the coordinated access (e.g., the first UE 606), and/or a set of UEs participating in the coordinated access. As shown by the example 600, the first UE 606 may transmit the indication shown by the reference number 612 based at least in part on a first COT resource 616 associated with a time duration that is prior to, and different from, the time duration 604.

As shown by reference number 618 and reference number 620, the second UE 608 and/or the third UE 610 may transmit a (respective) CAR and/or BSR. In some aspects, the second UE 608 and/or the third UE 610 may transmit the (respective) CAR and/or BSR based at least in part on receiving the request and/or pulling SCI from the first UE 606. Alternatively, either UE 608 or UE 610 may autonomously transmit the CAR and/or BSR, such as by transmitting the CAR and/or BSR based at least in part on identifying a presence of data in a data buffer that may be associated with a future transmission. Further, each of UE 608 and UE 610 may transmit a single instance of the CAR and/or BSR, or transmit updated CAR and/or BSR periodically. As one example, the pulling SCI may indicate to transmit periodic (updated) CAR and/or BSR. As another example, the pulling SCI may indicate to transmit a single instance of the CAR and/or BSR.

In the example 600, the second UE 608 and/or the third UE 610 may transmit the CAR and/or BSR based at least in part on the COT resource 616. For example, either or both UEs may transmit the CAR and/or BSR as SCI-2. However, in other examples, either or both UEs may use an alternative resource. In some aspects, a UE (e.g., the second UE 608 and/or the third UE 610) may identify a transmission resource (e.g., for transmitting the CAR and/or BSR) based at least in part on the groupcast ID transmitted by the first UE 606. As one example, each UE may be assigned a particular groupcast ID, and the UE may determine a PSFCH resource based at least in part on a using the groupcast ID as an address offset to determine the transmission resource. The UE may transmit the CAR and/or BSR in the identified transmission resource based at least in part on using a PSFCH and/or a PSSCH, such as by using a medium access control (MAC) control element (CE) associated with the PSFCH.

Based at least in part on acting as the coordinating UE, the first UE 606 may select and assign one or more (respective) resources to the second UE 608 and/or the third UE 610, as further described with regard to FIG. 7. As shown by reference number 622, the first UE 606 may transmit an indication 624 of one or more resource reservations associated with an unlicensed spectrum, such as by transmitting an indication of an interlace index associated with the COT structure 602. In some aspects, the transmission shown by reference number 622 may be referred to as coordinated access reservation SCI. As shown by the example 600, the coordinated access reservation SCI may indicate a first resource reservation that assigns a first interlace of the COT structure 602 to the first UE 606 (e.g., the interlace #0), a second interlace of the COT structure 602 to the second UE 608 (e.g., the interlace #2), and/or a third interlace of the COT structure 602 to the third UE 610 (e.g., the interlace #4). To illustrate, the first UE 606 may specify, via the indication 624, an interlace index and/or a UE ID associated with the interlace index. In some aspects, the first UE 606 may transmit, as part of the coordinated access reservation SCI, one or more LBT parameters associated with CAT 4 access to the COT structure 602, as further described with regard to FIG. 7. The first UE 606 may transmit the indication 624 based at least in part on a second COT resource 626 that is based at least in part on a different time duration than the time duration 604 associated with the COT structure 602 and a time duration associated with the first COT resource 616.

Based at least in part on the coordinated access reservation SCI transmitted by the first UE 606, the first UE 606, the second UE 608, and/or the third UE 610 may perform a CAT 4 LBT access procedure associated with accessing an assigned resource of the COT structure 602. In some aspects, each UE may perform the CAT 4 LBT access procedure based at least in part on respective contention windows that may be specified by the one or more LBT parameters. For example, the first UE 606 may perform the CAT 4 LBT access procedure based at least in part on a first contention window 628, the second UE 608 may perform the CAT 4 LBT access procedure based at least in part on a second contention window 630, and/or the third UE 610 may perform the CAT 4 LBT access procedure based at least in part on a third contention window 632. Each UE may transmit in an assigned resource of the COT structure 602 based at least in part on LBT clearing. To illustrate, the first UE 606 may transmit in the interlace #0 as shown by reference number 634, the second UE 608 may transmit in the interlace #2 as shown by reference number 636 and/or the third UE 610 may transmit in the interlace #4 as shown by reference number 638.

Coordinated access to an unlicensed spectrum enables a UE participating in the coordinated access to mitigate a transmission collision in sidelink communications. Mitigating a transmission collision may increase data throughput and/or reduce resource consumption by improving a signal quality, reducing recovery failures and/or errors at a receiver, and reducing retransmissions.

As indicated above, FIG. 6 is provided as an example. Other examples may differ from what is described with respect to FIG. 6.

FIG. 7 illustrates an example of a wireless communication process between a first UE 701 (e.g., a UE 120), a second UE 702 (e.g., another UE 120), and a third UE 703 (e.g., another UE 120) in a wireless communication network, in accordance with the present disclosure. In some aspects, the first UE 701 may act as a coordinating UE for coordinated access to an unlicensed spectrum. Alternatively or additionally, the second UE 702 and the third UE 703 may act as participating UEs in the coordinated access to the unlicensed spectrum. While the example 700 shows a single coordinating UE and two participating UEs, other examples may include more coordinating UEs, more participating UEs, and/or fewer participating UEs.

As shown by reference number 710, the first UE 701 may determine to act as a coordinating UE for coordinated access to an unlicensed spectrum. As one example, the first UE 701 may determine to act as the coordinating UE based at least in part on receiving an instruction from a network entity (e.g., a base station 110) to act as the coordinating UE. Alternatively or additionally, the first UE 701 may determine to act as the coordinating UE based at least in part on identifying a condition that indicates to act as the coordinating UE. To illustrate, the first UE 701 may receive (respective) coordinated access reservation SCI from one or more coordinating UEs and determine that some of the coordinated access reservation SCI is invalid. In some aspects, the first UE 701 may identify valid coordinated access reservation SCI based at least in part on an operating location of the transmitting coordinating UE. For instance, the first UE 701 may determine that the coordinate access reservation SCI is valid based at least in part on the operating location satisfying a distance threshold (e.g. the transmitting coordinating UE operates within range of the first UE 701) and determine that the coordinated access reservation SCI is invalid based at least in part on the operating location failing to satisfy the distance threshold. The first UE 701 may determine to act as a coordinating UE based at least in part on failing to receive valid coordinated access reservation sidelink control information from a requisite number of coordinating UEs. The requisite number may be based at least in part on satisfying a count threshold. The first UE 701 may act as a single coordinating UE for a set of UEs or may act as one of multiple coordinating UEs for the set of UEs.

As shown by reference number 720, the first UE 701 may transmit, and a second UE 702 and/or a third UE 703 may receive, an indication of a request for information associated with a future transmission. To illustrate, the first UE 701 may transmit the indication as a broadcast message and/or a groupcast message that multiple devices may receive and recover. As one example, the first UE 701 may transmit pulling SCI that requests the information from one or more UEs within receiving distance (e.g., a distance associated with successful recovery of the pulling SCI). Alternatively or additionally, the first UE 701 may transmit the pulling SCI as SCI-1 associated with a PSSCH transmission. In some aspects, the pulling SCI may include an indication of a request for a CAR and/or a BSR. Alternatively or additionally, the indication of the request may specify a groupcast ID associated with the transmission. While the example 700 shows the first UE 701 transmitting the indication of the request, the first UE 701 may refrain from transmitting the indication of the request in other examples.

As shown by reference number 730, the second UE 702 and/or the third UE 703 may transmit, and the first UE 701 may receive, information associated with a future transmission by the respective UE. As one example, a UE (e.g., the second UE 702 and/or the third UE 703) may transmit, as the information associated with the future transmission, an indication of a respective CAR and/or a respective BSR associated with the UE. To illustrate, based at least in part on receiving SCI-1 that indicates the request for information associated with the future transmission (e.g., the pulling SCI), the UE may transmit the CAR and/or BSR as SCI-2 that is based at least in part on the PSCCH used to receive the SCI-1. As another example, the UE may transmit a coordination message that indicates a recommended or UE-selected resource in the unlicensed spectrum. As one example, the second UE 702 and/or the third UE 703 may select the recommended resource based at least in part on generating a signal metric (e.g., RSRP or RSSI) that indicates a channel quality associated with the recommended resource.

The second UE 702 and/or the third UE 703 may transmit the information associated with the future transmission (e.g., a coordination message, CAR, and/or BSR) based at least in part on using PSFCH and/or PSCCH. In some aspects, a UE (e.g., the UE 701, the UE 702, and/or the UE 703) may determine a resource to use for transmission (or reception) of the information via PSFCH and/or PSCCH based at least in part on a groupcast ID associated with the request as shown by the reference number 720. Alternatively or additionally, the UE may identify the resource based at least in part on determining to transmit (or receive) the information using a MAC CE and/or as SCI-2 as further described above. Thus, a UE may transmit or receive the information based at least in part on determining and/or identifying the resource used to transmit the information.

In some aspects, a UE (e.g., the second UE 702 and/or the third UE 703) may transmit an indication of the information associated with the future transmission as groupcast SCI. Transmitting the indication of the information may include transmitting updated information periodically or autonomously as a single instance. As one example, the UE may determine to transmit a single instance of the information based at least in part on identifying that a condition has been satisfied, such as by identifying that an amount of data in a data buffer satisfies a quantity threshold. As another example, the UE may transmit updated information periodically based at least in part on receiving an instruction to transmit the updated information periodically. Thus, the UE may transmit the indication of the information based at least in part on receiving a request for the information and/or autonomously based at least in part on identifying that a condition has been satisfied. In some aspects, the UE may transmit the indication of the information based at least in part on determining to join the coordinated access managed, at least in part, by the first UE 701. While the example 700 shows the second UE 702 and/or the third UE 703 transmitting the information associated with a future transmission, the second UE 702 and/or the third UE 703 may refrain from transmitting the information in other examples.

As shown by reference number 740, the first UE 701 may determine one or more resource reservations, where a resource reservation may indicate an assignment of a resource to a UE. As one example, the resource reservation may indicate an assignment of a resource associated with a COT structure. In some aspects, the first UE 701 may determine the one or more resource reservations based at least in part on receiving the (respective) information associated with a future transmission from the second UE 702 and/or the third UE 703. In other aspects, the first UE 701 may determine the one or more resource reservations autonomously and/or independent of receiving the information associated with the future transmission. For instance, the first UE 701 may autonomously determine the resource reservations to pre-emptively avoid collisions by identifying each UE operating within a distance threshold to the first UE 701 and assigning a resource to each UE and/or instructing one or more UEs to refrain from transmitting in a resource.

In some aspects, as part of determining the resource reservation(s), the first UE 701 may determine and/or identify one or more LBT parameters associated with CAT 4 LBT access. Determining the LBT parameter(s) may include identifying respective LBT parameter(s) for each participating UE associated with the one or more resource reservations. Some example LBT parameters may include an LBT window (e.g., a contention window) associated with a start time and an end time for clearing LBT, a reserved COT slot, an ID of another UE that is participating in the coordinated access, and/or an interlace index associated with a reserved resource for the participating UE. As one example, the LBT parameter may indicate, as the reserved resource, a reserved COT (e.g., reserved for the UE), a reserved COT time slot, and/or a reserved COT sub-band. In some aspects, the time slot may be a COT time duration (e.g., the time duration 504 or the time duration 604) or a smaller time partition of the COT time duration. Alternatively or additionally, the first UE 701 may randomly select a backoff counter value from a range of values. In some aspects, the range of values used to select the random backoff counter value may be based at least in part on a priority. For example, the first UE 701 may select a first backoff counter value from a first range of values associated with CAPC 0 and a second backoff counter value from a second range of values associated with CAPC 3. Alternatively or additionally, the first UE 701 may modify a start time value and/or an end time value associated with a contention window based at least in part on the traffic priority. In some aspects, the first UE 701 may indicate a starting transmission time that is based at least in part on and/or associated with a Customer Premise Equipment.

Alternatively or additionally, an LBT parameter may indicate a reserve gap between the end time for clearing the LBT and transmitting in a reserved resource. A “reserve gap” may denote a time period during which no transmissions or receptions are scheduled and/or allowed to occur. As another example, an LBT parameter may indicate a joint start LBT time (e.g., a start time for a contention) for joint LBT by multiple UEs. To illustrate, the joint start LBT time may be a global LBT parameter used by all UEs in the set of UEs to define a start of a contention window. Based at least in part on the joint start LBT time, each UE may perform a respective LBT procedure in a same contention window (e.g., joint LBT). Alternatively or additionally, an LBT parameter may indicate a defer duration associated with joint LBT, where a defer duration may denote a delay to apply to a start LBT time duration. Indicating a joint LBT start time and/or a joint deter duration may enable the set of UEs to perform synchronous LBT procedures and reduce transmission collisions.

As part of determining one or more resource reservations, the first UE 701 may determine a set of UEs to include as participating UEs in the coordinated access. As one example, the first UE 701 may select a UE (e.g., the second UE 702 and/or the third UE 703) to include in the set based at least in part on receiving an indication of a future transmission from the UE. As another example, the first UE 701 may select the UE based at least in part on receiving a scheduling request from the UE. Thus, the first UE 701 may identify the scheduling request and/or the indication of the future transmission as a request to participate in the coordinated access. Alternatively or additionally, the first UE 701 may determine whether to include or exclude a UE from the set of UEs based at least in part on traffic priority, such as by determining to include a UE with higher traffic priority and/or exclude a UE with lower traffic priority relative to other UEs. Including or excluding a UE from the set of UEs based at least in part on traffic priority may help the first UE 701 assign a COT resource to higher priority transmissions first and mitigate transmission failures for the higher priority transmissions.

The first UE 701 may determine a resource reservation based at least in part on calculating a number of resources to reserve in the unlicensed spectrum. As one example, the first UE 701 may calculate the number of resources based at least in part on receiving a CAR and/or BSR from a UE (e.g., the second UE 702 and/or the third UE 703) and determine the resource reservation based at least in part on the calculated number. In some aspects, the first UE 701 may determine whether an operating location of the UE satisfies a distance threshold (e.g., the UE operates at a location within a distance threshold to the first UE 701). Based at least in part on whether the operating location satisfies the distance threshold, the first UE 701 may include or exclude the information (e.g., the CAR and/or BSR) from the calculations. Excluding information associated with a UE from the calculations may also indicate that the UE has been excluded from the set of UEs associated with the coordinated access to the unlicensed spectrum.

The first UE 701 may select a resource to assign to a participating UE based at least in part on a recommended and/or UE-selected resource indicated by the participating UE. Alternatively or additionally, the first UE 701 may select a resource based at least in part on receiving resource reservation information from another coordinating UE. To illustrate, the first UE 701 may refrain from selecting an assigned resource indicated by another coordinating UE.

As shown by reference number 750, the first UE 701 may transmit, and the second UE 702 and/or the third UE 703 may receive, an indication of one or more resource reservations. In some aspects, the first UE 701 may transmit the indication of the resource reservation(s) as coordinated access reservation SCI. The coordinated access reservation SCI may include and/or indicate multiple coordinated access parameters, where the coordinated access parameters may be UE-specific (e.g., associated with a specific UE) and/or global (e.g., associated with all UEs in the set of UEs). Some example coordinated access parameters may include a reserved LBT window, a zone ID associated with the first UE 701 (e.g., acting as a coordinating UE), a range of coordination associated with the first UE 701, or a CAPC value associated with resource reservation capabilities. A reserved LBT window may be associated with a start time and/or an end time of a contention window. A zone ID may indicate an operating area and/or location associated with the first UE 701. A range of coordination may indicate a range and/or distance of a participating UE (e.g., from the first UE 70) that the first UE 701 supports for coordinated access. A maximum CAPC value may indicate a highest CAPC supported and/or prioritized by the first UE 701.

In some aspects, the coordinated access reservation SCI may indicate a set of UEs eligible to participate in the coordinated access to unlicensed spectrum (e.g., a set of UEs selected by the first UE 701). The coordinated access reservation SCI may alternatively or additionally indicate, for each UE in the set of UEs, a resource reservation. To illustrate, a UE-specific resource reservation may indicate an interlace index assigned to the UE, one or more sub-bands assigned to the UE, and/or an ID of the UE. For example, an interlace may be partitioned into multiple sub-bands and a resource reservation may indicate one or more of the sub-bands of the interlace. Alternatively or additionally, an interlace may be partitioned into multiple frequency partitions and a resource reservation may indicate one or more of the frequency partitions. In some aspects, the coordinated access reservation SCI may indicate a UE-specific backoff value that may be based at least in part on a CAPC value associated with a future transmission by the UE.

The first UE 701 may implicitly indicate, to a non-participating UE and as part of the coordinated access reservation SCI, to refrain from transmitting in a resource associated with the resource reservation. For example, the first UE 701 may transmit the coordinated access reservation SCI as a broadcast and/or groupcast message that any UE within receiving range can receive and recover. “Any UE” may include a non-participating UE, where “non-participating UE” may denote a UE that is excluded from the set of UEs and/or a UE that has determined to refrain from joining the coordinated access. In some aspects, “any UE” may include another coordinating UE that either manages a same cluster as the first UE 701 or a different cluster (with a different set of UEs). Accordingly, a first coordinating UE may communicate a resource reservation and/or coordinated access reservation SCI to a second coordinating UE. The coordinating access reservation SCI may indicate, to a non-participating UE and/or another coordinating UE, a resource assigned by the first UE 701, and implicitly indicate to refrain from transmitting in the assigned resource and/or to refrain from assigning the resource.

As shown by reference number 760, the first UE 701, the second UE 702, and/or the third UE 703 may transmit one or more sidelink communications based at least in part on the resource reservation(s) shown by the reference number 750. For example, the first UE 701 may transmit a first sidelink communication based at least in part on a resource reservation associated with the first UE 701, the second UE 702 may transmit a second sidelink communication based at least in part on a resource reservation associated with the second UE 702, and/or the third UE 703 may transmit a third sidelink communication based at least in part on a resource reservation associated with the third UE 703.

In some aspects, a UE (e.g., the second UE 702 and/or the third UE 703) may determine to refrain from participating in the coordinated access. Refraining from participating may include refraining from transmitting a sidelink communication using a resource that is based at least in part on the resource reservation (and/or other configuration parameters indicated by the coordinated access reservation SCI) shown by the reference number 750. To illustrate, the UE may determine whether to participate in the coordinated access to the unlicensed spectrum based at least in part on the coordinated access reservation SCI. For instance, the UE may determine that a start time associated with a reserved LBT window indicated by the coordinated access reservation SCI fails to satisfy a packet delay budget associated with the UE. Based at least in part on the start time failing to satisfy the packet delay budget, the UE may determine to refrain from participating in the coordinated access. Other examples that may cause the UE to refrain from participating may include the UE determining that a zone identifier associated with a coordinating UE indicates that an operating location of the coordinating UE fails to satisfy a distance threshold associated with the UE, that a range of coordination associated with the coordinating UE fails to satisfy a range threshold associated with the UE, and/or that a maximum CAPC value fails to satisfy a traffic CAPC threshold associated with the UE.

As shown by reference number 770, the first UE 701, the second UE 702, and/or the third UE 703 may iteratively perform some or all of the signaling and/or actions shown by the example 700, such as any combination of requesting information associated with a future transmission, transmitting the information associated with the future transmission, determining an updated resource reservation, transmitting updated coordinated access reservation SCI, and/or transmitting a sidelink communication based at least in part on the updated coordinated access reservation SCI. As one example of updated coordinated access reservation SCI, the first UE 701 may update a contention window value (e.g., a start time value and/or an end time value) based at least in part on a modified and/or observed link (e.g., based at least in part on a modified CAPC value) associated with the contention window and/or a UE associated with the contention window. While the example 700 shows the iterations returning at the reference number 720, other example iterations may return at other signaling and/or transactions shown by the example 700.

As shown by reference number 780, the first UE 701 may cease acting as the coordinating UE. As one example, the first UE 701 may cease acting as the coordinating UE based at least in part on receiving an instruction from a network entity (e.g., a base station 110) that specifies to cease acting as a coordinating UE. As another example, the first UE 701 may repeatedly transmit coordinated access reservation SCI for a time duration while failing to receive a CAR and/or BSR from a UE. To illustrate, the first UE 701 may repeatedly transmit, during the time duration, the request shown by the reference number 720 and fail to receive, during the time duration, the information shown by the reference number 730. Alternatively or additionally, the first UE 701 may repeatedly transmit, during the time duration, the coordinated access reservation SCI shown by the reference number 750 while receiving, during the time duration, (only) BSR that indicates an empty data buffer. At an expiration of the time duration, the first UE 701 may determine to cease transmitting the coordinated access reservation SCI and/or to cease acting as the coordinating UE.

By coordinating LBT channel access to an unlicensed spectrum, a coordinating UE may mitigate other UEs operating within a distance threshold of one another selecting a same resource (e.g., an interlace associated with a COT) and mitigate transmission collisions, such as collisions in sidelink communications. Mitigating transmission collisions may improve the sidelink communications by reducing recovery failures and/or errors at a receiver, increasing data throughput, and/or reducing resource consumption.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with coordinated access to an unlicensed spectrum.

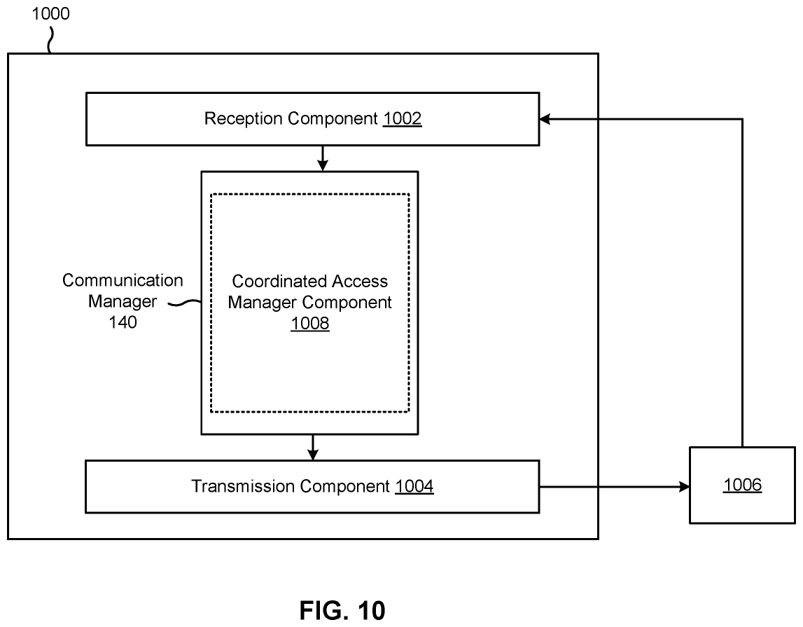

As shown in FIG. 8, in some aspects, process 800 may include transmitting an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to a participating UE associated with coordinated access to the unlicensed spectrum (block 810). For example, the UE (e.g., using communication manager 140 and/or transmission component 1004, depicted in FIG. 10) may transmit an indication of a resource reservation associated with an unlicensed spectrum, the indication specifying at least an LBT parameter associated with a channel access procedure for accessing the unlicensed spectrum (e.g., LBT access) and an interlace index associated with a resource in the unlicensed spectrum assigned to a participating UE associated with coordinated access to the unlicensed spectrum, as described above.

As further shown in FIG. 8, in some aspects, process 800 may include communicating in a wireless network based at least in part on the resource reservation associated with the unlicensed spectrum, the LBT parameter, and the interlace index (block 820). For example, the UE (e.g., using communication manager 140, transmission component 1004, and/or reception component 1002, depicted in FIG. 10) may communicate in a wireless network based at least in part on the resource reservation associated with the unlicensed spectrum, the LBT parameter, and the interlace index, as described above.

Process 800 may include additional aspects, such as any single aspect or any combination of aspects described below and/or in connection with one or more other processes described elsewhere herein.

In a first aspect, the UE is a coordinating UE and the process 800 includes receiving, from the participating UE, a coordination message that indicates a recommended resource in the unlicensed spectrum.

In a second aspect, alone or in combination with the first aspect, the coordination message indicates a start time associated with the recommended resource.

In a third aspect, alone or in combination with one or more of the first and second aspects, communicating in the wireless network may include communicating in the wireless network based at least in part on the recommended resource.

In a fourth aspect, alone or in combination with one or more of the first through third aspects, the resource reservation associated with the unlicensed spectrum is based at least in part on the recommended resource.

In a fifth aspect, alone or in combination with one or more of the first through fourth aspects, transmitting the indication may include transmitting the indication based at least in part on coordinated access reservation SCI.

In a sixth aspect, alone or in combination with one or more of the first through fifth aspects, the UE is a coordinating UE, and the process 800 includes assigning a resource in the unlicensed spectrum to the participating UE. In some aspects, the resource reservation indicates the resource.

In a seventh aspect, alone or in combination with one or more of the first through sixth aspects, the resource is associated with a channel occupancy time structure.

In an eighth aspect, alone or in combination with one or more of the first through seventh aspects, the UE is a coordinating UE, the indication of the resource reservation is a first indication, and the process 800 includes receiving, from the participating UE, a second indication that specifies at least one of a CAR or a buffer status report, and calculating a number of resources in the unlicensed spectrum to reserve based at least in part on the second indication. In some aspects, the resource reservation is based at least in part on the calculated number of resources.

In a ninth aspect, alone or in combination with one or more of the first through eighth aspects, receiving the second indication may include recovering the CAR or the BSR from groupcast SCI.

In a tenth aspect, alone or in combination with one or more of the first through ninth aspects, receiving the second indication may include receiving the second indication periodically, or receiving the second indication based at least in part on a condition being satisfied.

In an eleventh aspect, alone or in combination with one or more of the first through tenth aspects, receiving the second indication may include receiving the second indication based at least in part on a physical sidelink feedback channel, or a physical sidelink shared channel.

In a twelfth aspect, alone or in combination with one or more of the first through eleventh aspects, process 800 includes determining a receiving resource based at least in part on a groupcast identifier, a MAC CE, or second stage sidelink control information. In some aspects, receiving the second indication may include receiving the second indication based at least in part on the receiving resource.

In a thirteenth aspect, alone or in combination with one or more of the first through twelfth aspects, process 800 includes calculating the number of resources in unlicensed spectrum to reserve based at least in part on a location of the participating UE satisfying a distance threshold.

In a fourteenth aspect, alone or in combination with one or more of the first through thirteenth aspects, receiving the second indication may include receiving the second indication based at least in part on receiving a scheduling request.

In a fifteenth aspect, alone or in combination with one or more of the first through fourteenth aspects, process 800 includes determining a set of UEs based at least in part on receiving the second indication from the participating UE. In some aspects, the set of UEs includes the participating UE and transmitting the first indication includes transmitting the first indication to each UE in the set of UEs.

In a sixteenth aspect, alone or in combination with one or more of the first through fifteenth aspects, process 800 includes determining to include the participating UE in the set of UEs based at least in part on identifying the second indication as a request to participate in the coordinated access to the unlicensed spectrum.

In a seventeenth aspect, alone or in combination with one or more of the first through sixteenth aspects, determining the set of UEs may include determining the set of UEs based at least in part on traffic priority.

In an eighteenth aspect, alone or in combination with one or more of the first through seventeenth aspects, process 800 includes transmitting, as the first indication, coordinated access reservation SCI that is based at least in part on the second indication.

In a nineteenth aspect, alone or in combination with one or more of the first through eighteenth aspects, the coordinated access reservation SCI may include at least one of a reserved LBT window, a zone identifier associated with the coordinating UE, a range of coordination associated with the coordinating UE, or a maximum channel access priority class value associated with resource reservation capabilities.

In a twentieth aspect, alone or in combination with one or more of the first through nineteenth aspects, the LBT parameter may include at least one of an LBT window associated with a start time and an end time for clearing LBT, a reserved channel occupancy time slot, an identifier of a participating UE associated with the coordinated access to the unlicensed spectrum, or an interlace index associated with a reserved resource for the participating UE.

In a twenty-first aspect, alone or in combination with one or more of the first through twentieth aspects, the LBT parameter may include at least one of a reserve gap between the end time for clearing the LBT and transmitting in a reserved resource, or a joint start LBT time for joint LBT by multiple UEs.

In a twenty-second aspect, alone or in combination with one or more of the first through twenty-first aspects, the LBT parameter may include at least one of a backoff counter value, a starting transmission time associated with a Customer Premise Equipment, or a defer duration associated with joint LBT.

In a twenty-third aspect, alone or in combination with one or more of the first through twenty-second aspects, the indication further indicates a set of UEs eligible to participate in the coordinated access to unlicensed spectrum.

In a twenty-fourth aspect, alone or in combination with one or more of the first through twenty-third aspects, the indication of the resource reservation further indicates, for each UE in a set of UEs participating in the coordinated access to unlicensed spectrum, at least one of an interlace index assigned to the UE in the set, one or more sub-bands assigned to the UE in the set, or an identifier of the UE in the set.

In a twenty-fifth aspect, alone or in combination with one or more of the first through twenty-fourth aspects, process 800 includes indicating, to a non-participating UE, to refrain from transmitting in a resource associated with the resource reservation.

In a twenty-sixth aspect, alone or in combination with one or more of the first through twenty-fifth aspects, process 800 includes receiving, from a network entity, an instruction to act as a coordinating UE for the coordinated access to the unlicensed spectrum.

In a twenty-seventh aspect, alone or in combination with one or more of the first through twenty-sixth aspects, process 800 includes failing to receive, prior to transmitting the indication of the resource reservation associated with unlicensed spectrum, valid coordinated access reservation SCI from a number of coordinating UEs that satisfies a count threshold, and determining to act as a coordinating UE for coordinated access to the unlicensed spectrum based at least in part on the number failing to satisfy the count threshold.

In a twenty-eighth aspect, alone or in combination with one or more of the first through twenty-seventh aspects, determining to act as the coordinating UE may include determining to act as one of multiple coordinating UEs for a set of UEs participating in a cluster for coordinated access to the unlicensed spectrum.

In a twenty-ninth aspect, alone or in combination with one or more of the first through twenty-eighth aspects, process 800 includes identifying valid coordinated access reservation SCI based at least in part on a distance threshold.

In a thirtieth aspect, alone or in combination with one or more of the first through twenty-ninth aspects, process 800 includes selecting a random backoff counter value from a range of values. In some aspects, the range of values is based at least in part on a priority. Alternatively or additionally, process 800 may include signaling the random backoff counter value in coordinated access reservation SCI.

In a thirty-first aspect, alone or in combination with one or more of the first through thirtieth aspects, process 800 includes receiving a CAR or a BSR from the participating UE, and transmitting coordinated access reservation SCI repeatedly based at least in part on the receiving.

In a thirty-second aspect, alone or in combination with one or more of the first through thirty-first aspects, process 800 includes receiving, from one or more UEs in a set of participating UEs associated with the coordinated access to the unlicensed spectrum, a respective CAR or a respective buffer status report. In some aspects, the set of participating UEs includes the participating UE, and the process 800 includes transmitting coordinated access reservation SCI iteratively. For each iteration, the coordinated access reservation SCI may be based at least in part on at least one of the respective CAR or the respective buffer status report.

In a thirty-third aspect, alone or in combination with one or more of the first through thirty-second aspects, process 800 includes transmitting, for a time duration, coordinated access reservation SCI repeatedly based at least in part on an empty data buffer associated with failing to receive a CAR or a buffer status report, and ceasing to transmit the coordinated access reservation SCI at an expiration of the time duration.

In a thirty-fourth aspect, alone or in combination with one or more of the first through thirty-third aspects, process 800 includes ceasing to act as the coordinating UE at the expiration of the time duration.

In a thirty-fifth aspect, alone or in combination with one or more of the first through thirty-fourth aspects, process 800 includes maintaining a contention window value based at least in part on acting as the coordinating UE, and updating the contention window value based at least in part on an observed link associated with a contention window that is based at least in part on the contention window value.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a UE, in accordance with the present disclosure. Example process 900 is an example where the UE (e.g., UE 120) performs operations associated with coordinated access to an unlicensed spectrum.

As shown in FIG. 9, in some aspects, process 900 may include receiving an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to the UE, the indication associated with coordinated access to the unlicensed spectrum (block 910). As one example, the channel access procedure may be a CAT 4 access procedure.

As further shown in FIG. 9, in some aspects, process 900 may include communicating in a wireless network based at least in part on the resource reservation associated with the unlicensed spectrum, the LBT parameter, and the interlace index (block 920). For example, the UE (e.g., using communication manager 140, transmission component 1004, and/or reception component 1002, depicted in FIG. 10) may communicate in a wireless network based at least in part on the resource reservation associated with the unlicensed spectrum, the LBT parameter, and the interlace index, as described above.

Process 900 may include additional aspects, such as any single aspect or any combination of aspects described below and/or in connection with one or more other processes described elsewhere herein.

In a first aspect, the UE is a participating UE associated with the coordinated access to the unlicensed spectrum, and the process 900 includes transmitting a coordination message that indicates a recommended resource in the unlicensed spectrum.

In a second aspect, alone or in combination with the first aspect, the coordination message indicates a start time associated with the recommended resource.

In a third aspect, alone or in combination with one or more of the first and second aspects, communicating in the wireless network may include communicating in the wireless network based at least in part on the recommended resource.

In a fourth aspect, alone or in combination with one or more of the first through third aspects, the resource reservation associated with the unlicensed spectrum is based at least in part on the recommended resource.

In a fifth aspect, alone or in combination with one or more of the first through fourth aspects, receiving the indication may include transmitting the indication based at least in part on coordinated access reservation SCI.

In a sixth aspect, alone or in combination with one or more of the first through fifth aspects, the UE is a participating UE associated with the coordinated access to the unlicensed spectrum, and the process 900 includes receiving, from a coordinating UE associated with the coordinated access to the unlicensed spectrum, an assigned resource associated with the unlicensed spectrum. In some aspects, the resource reservation indicates the assigned resource.

In a seventh aspect, alone or in combination with one or more of the first through sixth aspects, the resource is associated with a channel occupancy time structure.

In an eighth aspect, alone or in combination with one or more of the first through seventh aspects, the UE is a participating UE associated with the coordinated access to the unlicensed spectrum, the indication of the resource reservation is a first indication, and the process 900 includes transmitting a second indication that specifies at least one of a CAR or a buffer status report.

In a ninth aspect, alone or in combination with one or more of the first through eighth aspects, transmitting the second indication may include transmitting the CAR or the BSR based at least in part on groupcast SCI.

In a tenth aspect, alone or in combination with one or more of the first through ninth aspects, transmitting the second indication may include transmitting the second indication periodically.

In an eleventh aspect, alone or in combination with one or more of the first through tenth aspects, transmitting the second indication may include transmitting the second indication based at least in part on a physical sidelink feedback channel, or a physical sidelink shared channel.

In a twelfth aspect, alone or in combination with one or more of the first through eleventh aspects, process 900 includes determining a transmission resource based at least in part on a groupcast identifier, a MAC CE, or a second stage sidelink control information. In some aspects, transmitting the second may include transmitting the second indication based at least in part on the transmission resource.

In a thirteenth aspect, alone or in combination with one or more of the first through twelfth aspects, transmitting the second indication may include transmitting the second indication based at least in part on transmitting a scheduling request.

In a fourteenth aspect, alone or in combination with one or more of the first through thirteenth aspects, process 900 includes receiving, as the first indication, coordinated access reservation SCI that is based at least in part on the second indication.

In a fifteenth aspect, alone or in combination with one or more of the first through fourteenth aspects, the coordinated access reservation SCI may include at least one of a reserved LBT window, a zone identifier associated with a coordinating UE, a range of coordination associated with the coordinating UE, or a maximum channel access priority class value associated with resource reservation capabilities.

In a sixteenth aspect, alone or in combination with one or more of the first through fifteenth aspects, process 900 includes determining whether to participate in the coordinated access to the unlicensed spectrum based at least in part on the coordinated access reservation SCI.

In a seventeenth aspect, alone or in combination with one or more of the first through sixteenth aspects, process 900 includes determining to refrain from participating in the coordinated access to the unlicensed spectrum. In some aspects, communicating in the wireless network may include refraining from transmitting in the wireless network based at least in part on the resource reservation associated with the unlicensed spectrum, the LBT parameter, and the interlace index.

In an eighteenth aspect, alone or in combination with one or more of the first through seventeenth aspects, determining to refrain from participating in the coordinated access may include determining to refrain from participating in the coordinated access based at least in part on one of a start time associated with the reserved LBT window failing to satisfy a packet delay budget associated with the UE, the zone identifier indicating that the coordinating UE is located at a position that fails to satisfy a distance threshold, the range of coordination associated with the coordinating UE failing to satisfy a range threshold, or the maximum channel access priority class value failing to satisfy a traffic channel access priority class threshold.

In a nineteenth aspect, alone or in combination with one or more of the first through eighteenth aspects, process 900 includes determining to join the coordinated access to the unlicensed spectrum, and transmitting a CAR based at least in part on the determining.

In a twentieth aspect, alone or in combination with one or more of the first through nineteenth aspects, the LBT parameter may include at least one of an LBT window associated with a start time and an end time for clearing LBT, a reserved channel occupancy time slot, an identifier of the UE, or an interlace index associated with a reserved resource for the UE.

In a twenty-first aspect, alone or in combination with one or more of the first through twentieth aspects, the LBT parameter may include at least one of a reserve gap between the end time for clearing the LBT and transmitting in a reserved resource, or a joint start LBT time for joint LBT by multiple UEs.

In a twenty-second aspect, alone or in combination with one or more of the first through twenty-first aspects, the LBT parameter may include at least one of a backoff counter value, a starting transmission time associated with a Customer Premise Equipment, or a defer duration associated with joint LBT.

In a twenty-third aspect, alone or in combination with one or more of the first through twenty-second aspects, the indication further indicates a set of UEs eligible to participate in the coordinated access to unlicensed spectrum.

In a twenty-fourth aspect, alone or in combination with one or more of the first through twenty-third aspects, the indication of the resource reservation further indicates, for each UE in a set of UEs participating in the coordinated access to unlicensed spectrum, at least one of an interlace index assigned to the UE in the set, one or more sub-bands assigned to the UE in the set, or an identifier of the UE in the set.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include one or more of a coordinated access manager component 1008, among other examples.

In some aspects, the apparatus 1000 may be configured to perform one or more operations described herein in connection with FIGS. 3-9. Additionally, or alternatively, the apparatus 1000 may be configured to perform one or more processes described herein, such as process 800 of FIG. 8, process 900 of FIG. 9, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The transmission component 1004 may transmit an indication of a resource reservation associated with an unlicensed spectrum, the indication specifying at least an LBT parameter associated with a channel access procedure for accessing the unlicensed spectrum and an interlace index associated with a resource in the unlicensed spectrum assigned to a participating UE associated with coordinated access to the unlicensed spectrum. As one example, the channel access procedure may be a CAT 4 access procedure. The coordinated access manager component 1008 may manage resource reservations and enable the apparatus 1000 to communicate in a wireless network based at least in part on the resource reservation associated with the unlicensed spectrum, the LBT parameter, and the interlace index.

The coordinated access manager component 1008 may determine a receiving resource based at least in part on a groupcast identifier, a MAC CE, or SCI-2. Alternatively or additionally, the coordinated access manager component 1008 may calculate the number of resources in unlicensed spectrum to reserve based at least in part on a location of the participating UE satisfying a distance threshold. In some aspects, the coordinated access manager component 1008 may determine a set of UEs based at least in part on receiving the second indication from the participating UE, and the set of UEs may include the participating UE. The coordinated access manager component 1008 may determine to include the participating UE in the set of UEs based at least in part on identifying the second indication as a request to participate in the coordinated access to the unlicensed spectrum.

The transmission component 1004 may transmit, as the first indication, coordinated access reservation SCI that is based at least in part on the second indication. The transmission component 1004 may transmit the first indication to each UE in the set of UEs based at least in part on an instruction from the coordinated access manager component 1008.

The coordinated access manager component 1008 may indicate, to a non-participating UE, to refrain from transmitting in a resource associated with the resource reservation. In some aspects, the coordinated access manager component 1008 may receive, from a network entity and by way of the reception component 1002, an instruction to act as a coordinating UE for the coordinated access to the unlicensed spectrum.

The coordinated access manager component 1008 may fail to receive, prior to transmitting the indication of the resource reservation associated with unlicensed spectrum and by way of the reception component 1002, valid coordinated access reservation SCI from a number of coordinating UEs that satisfies a count threshold. In some aspects, the coordinated access manager component 1008 may determine to act as a coordinating UE for coordinated access to the unlicensed spectrum based at least in part on the number failing to satisfy the count threshold.

The coordinated access manager component 1008 may identify valid coordinated access reservation SCI based at least in part on a distance threshold. Alternatively or additionally, the coordinated access manager component 1008 may select a random backoff counter value from a range of values. In some aspects, the range of values may be based at least in part on a priority. By way of the transmission component 1004, the coordinated access manager component 1008 may signal the random backoff counter value in coordinated access reservation SCI.

The coordinated access manager component 1008 may receive, by way of the reception component 1002, a CAR or a BSR from the participating UE. In some aspects, the coordinated access manager component 1008 may transmit, by way of the transmission component 1004, coordinated access reservation SCI repeatedly based at least in part on the receiving.

The coordinated access manager component 1008 may receive, by way of the reception component 1002 and from one or more UEs in a set of participating UEs associated with the coordinated access to the unlicensed spectrum, a respective CAR or a respective BSR, where the set of participating UEs includes the participating UE.

The coordinated access manager component 1008 may transmit, by way of the transmission component 1004, coordinated access reservation SCI iteratively. For each iteration, the coordinated access reservation SCI may be based at least in part on at least one of the respective CAR or the respective BSR.

The coordinated access manager component 1008 may transmit, by way of the transmission component 1004 and for a time duration, coordinated access reservation SCI repeatedly, based at least in part on an empty data buffer associated with failing to receive a CAR or a BSR. The coordinated access manager component 1008 may cease to transmit the coordinated access reservation SCI at an expiration of the time duration. Alternatively or additionally, the coordinated access manager component 1008 may cease to act as the coordinating UE at the expiration of the time duration.

The coordinated access manager component 1008 may maintain a contention window value based at least in part on acting as the coordinating UE. In some aspects, the coordinated access manager component 1008 may update the contention window value based at least in part on an observed link associated with a contention window that is based at least in part on the contention window value.

The reception component 1002 may receive an indication of a resource reservation associated with an unlicensed spectrum, where the indication specifies at least an LBT parameter associated with a channel access procedure for accessing the unlicensed spectrum and an interlace index associated with a resource in the unlicensed spectrum assigned to the UE. As one example, the channel access procedure may be a CAT 4 access procedure. The indication may be associated with coordinated access to the unlicensed spectrum that the UE is participating in. The coordinated access manager component 1008 may communicate, by way of the reception component 1002 and/or the transmission component 1004, in a wireless network based at least in part on the resource reservation associated with the unlicensed spectrum, the LBT parameter, and the interlace index.

The coordinated access manager component 1008 may determine a transmission resource based at least in part on a groupcast identifier, a MAC CE, or SCI-2.

In some aspects, the coordinated access manager component 1008 may receive, by way of the reception component 1002 and as the first indication, coordinated access reservation SCI that is based at least in part on the second indication. The coordinated access manager component 1008 may determine whether to participate in the coordinated access to the unlicensed spectrum based at least in part on the coordinated access reservation SCI. As one example, the coordinated access manager component 1008 may determine to refrain from participating in the coordinated access to the unlicensed spectrum. Communicating in the wireless network by refraining from participating may include refraining from transmitting in the wireless network based at least in part on the resource reservation associated with the unlicensed spectrum, the LBT parameter, and the interlace index. Alternatively or additionally, the coordinated access manager component 1008 may determine to join the coordinated access to the unlicensed spectrum. In some aspects, the coordinated access manager component 1008 may transmit, by way of the transmission component 1004, a CAR based at least in part on the determining.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:
Aspect 1: A method of wireless communication performed by a user equipment (UE), comprising: transmitting an indication of a resource reservation associated with an unlicensed spectrum, the indication specifying at least a listen-before-talk (LBT) parameter associated with a channel access procedure for accessing the unlicensed spectrum to the unlicensed spectrum and an interlace index associated with a resource in the unlicensed spectrum assigned to a participating UE associated with coordinated access to the unlicensed spectrum; and communicating in a wireless network based at least in part on the resource reservation associated with the unlicensed spectrum, the LBT parameter, and the interlace index.
Aspect 2: The method of Aspect 1, wherein the UE is a coordinating UE and the method further comprises: receiving, from the participating UE, a coordination message that indicates a recommended resource in the unlicensed spectrum.
Aspect 3: The method of Aspect 2, wherein the coordination message indicates a start time associated with the recommended resource.
Aspect 4: The method of Aspect 2 or Aspect 3, wherein communicating in the wireless network comprises: communicating in the wireless network based at least in part on the recommended resource.
Aspect 5: The method of any one of Aspects 2-4, wherein the resource reservation associated with the unlicensed spectrum is based at least in part on the recommended resource.
Aspect 6: The method of any one of Aspects 1-5, wherein transmitting the indication further comprises: transmitting the indication based at least in part on coordinated access reservation sidelink control information.
Aspect 7: The method of any one of Aspects 1-6, wherein the UE is a coordinating UE, and the method further comprises: assigning a resource in the unlicensed spectrum to the participating UE, wherein the resource reservation indicates the resource.
Aspect 8: The method of Aspect 7, wherein the resource is associated with a channel occupancy time structure.
Aspect 9: The method of any one of Aspects 1-8, wherein the UE is a coordinating UE, the indication of the resource reservation is a first indication, and the method further comprises: receiving, from the participating UE, a second indication that specifies at least one of: a channel access request or a buffer status report; and calculating a number of resources in the unlicensed spectrum to reserve based at least in part on the second indication, wherein the resource reservation is based at least in part on the calculated number of resources.
Aspect 10: The method of Aspect 9, wherein receiving the second indication further comprises recovering the channel access request or the buffer status report from groupcast sidelink control information.
Aspect 11: The method of Aspect 10, wherein receiving the second indication further comprises: receiving the second indication periodically; or receiving the second indication based at least in part on a condition being satisfied.
Aspect 12: The method of Aspect 10 or Aspect 11, wherein receiving the second indication further comprises: receiving the second indication based at least in part on: a physical sidelink feedback channel, or a physical sidelink shared channel.
Aspect 13: The method of Aspect 12, further comprising: determining a receiving resource based at least in part on: a groupcast identifier, a medium access control (MAC) control element (CE), or second stage sidelink control information, and wherein receiving the second indication further comprises receiving the second indication based at least in part on the receiving resource, wherein receiving the second indication further comprises receiving the second indication based at least in part on the receiving resource.
Aspect 14: The method of any one of Aspects 9-13, further comprising: calculating the number of resources in unlicensed spectrum to reserve based at least in part on a location of the participating UE satisfying a distance threshold.
Aspect 15: The method of any one of Aspects 9-14, wherein receiving the second indication further comprises: receiving the second indication based at least in part on receiving a scheduling request.
Aspect 16: The method of any one of Aspects 9-15, further comprising: determining a set of UEs based at least in part on receiving the second indication from the participating UE, wherein the set of UEs includes the participating UE, wherein transmitting the first indication further comprises: transmitting the first indication to each UE in the set of UEs.
Aspect 17: The method of Aspect 16, further comprising: determining to include the participating UE in the set of UEs based at least in part on identifying the second indication as a request to participate in the coordinated access to the unlicensed spectrum.
Aspect 18: The method of Aspect 16 or Aspect 17, wherein determining the set of UEs further comprises: determining the set of UEs based at least in part on traffic priority.
Aspect 19: The method of any one of Aspects 9-18, further comprising: transmitting, as the first indication, coordinated access reservation sidelink control information that is based at least in part on the second indication.
Aspect 20: The method of Aspect 19, wherein the coordinated access reservation sidelink control information comprises at least one of: a reserved LBT window, a zone identifier associated with the coordinating UE, a range of coordination associated with the coordinating UE, or a maximum channel access priority class value associated with resource reservation capabilities.
Aspect 21: The method of any one of Aspects 1-20, wherein the LBT parameter comprises at least one of: an LBT window associated with a start time and an end time for clearing LBT, a reserved channel occupancy time slot, an identifier of a participating UE associated with the coordinated access to the unlicensed spectrum, or an interlace index associated with a reserved resource for the participating UE.
Aspect 22: The method of Aspect 21, wherein the LBT parameter further comprises at least one of: a reserve gap between the end time for clearing the LBT and transmitting in a reserved resource, or a joint start LBT time for joint LBT by multiple UEs.
Aspect 23: The method of Aspect 21 or Aspect 22, wherein the LBT parameter further comprises at least one of: a backoff counter value, a starting transmission time associated with a Customer Premise Equipment, or a defer duration associated with joint LBT.
Aspect 24: The method of any one of Aspects 1-23, wherein the indication further indicates a set of UEs eligible to participate in the coordinated access to unlicensed spectrum.
Aspect 25: The method of any one of Aspects 1-24, wherein the indication of the resource reservation further indicates, for each UE in a set of UEs participating in the coordinated access to unlicensed spectrum, at least one of: an interlace index assigned to the UE in the set, one or more sub-bands assigned to the UE in the set, or an identifier of the UE in the set.
Aspect 26: The method of any one of Aspects 1-25, further comprising: indicating, to a non-participating UE, to refrain from transmitting in a resource associated with the resource reservation.
Aspect 27: The method of any one of Aspects 1-26, further comprising: receiving, from a network entity, an instruction to act as a coordinating UE for the coordinated access to the unlicensed spectrum.
Aspect 28: The method of any one of Aspects 1-27, further comprising: failing to receive, prior to transmitting the indication of the resource reservation associated with unlicensed spectrum, valid coordinated access reservation sidelink control information from a number of coordinating UEs that satisfies a count threshold; and determining to act as a coordinating UE for coordinated access to the unlicensed spectrum based at least in part on the number failing to satisfy the count threshold.
Aspect 29: The method of Aspect 28, wherein determining to act as the coordinating UE comprises: determining to act as one of multiple coordinating UEs for a set of UEs participating in a cluster for coordinated access to the unlicensed spectrum.
Aspect 30: The method of Aspect 28 or Aspect 29, further comprising: identifying valid coordinated access reservation sidelink control information based at least in part on a distance threshold.
Aspect 31: The method of any one of Aspects 28-30, further comprising: selecting a random backoff counter value from a range of values, wherein the range of values is based at least in part on a priority; and signaling the random backoff counter value in coordinated access reservation sidelink control information.
Aspect 32: The method of any one of Aspects 28-31, further comprising: receiving a channel access request or a buffer status report from the participating UE; and transmitting coordinated access reservation sidelink control information repeatedly based at least in part on the receiving.
Aspect 33: The method of any one of Aspects 28-32, further comprising: receiving, from one or more UEs in a set of participating UEs associated with the coordinated access to the unlicensed spectrum, a respective channel access request or a respective buffer status report, wherein the set of participating UEs includes the participating UE; and transmitting coordinated access reservation sidelink control information iteratively, wherein, for each iteration, the coordinated access reservation sidelink control information is based at least in part on at least one of the respective channel access request or the respective buffer status report.
Aspect 34: The method of any one of Aspects 28-Aspect 33, further comprising: transmitting, for a time duration, coordinated access reservation sidelink control information repeatedly based at least in part on an empty data buffer associated with failing to receive a channel access request or a buffer status report; and ceasing to transmit the coordinated access reservation sidelink control information at an expiration of the time duration.
Aspect 35: The method of Aspect 34, further comprising: ceasing to act as the coordinating UE at the expiration of the time duration.
Aspect 36: The method of any one of Aspects 28-35, further comprising: maintaining a contention window value based at least in part on acting as the coordinating UE; and updating the contention window value based at least in part on an observed link associated with a contention window that is based at least in part on the contention window value.
Aspect 37: A method of wireless communication performed by a user equipment (UE), comprising: receiving an indication of a resource reservation associated with an unlicensed spectrum, the indication specifying at least a listen-before-talk (LBT) parameter associated with a channel access procedure for accessing the unlicensed spectrum the unlicensed spectrum and an interlace index associated with a resource in the unlicensed spectrum assigned to the UE, the indication associated with coordinated access to the unlicensed spectrum; and communicating in a wireless network based at least in part on the resource reservation associated with the unlicensed spectrum, the LBT parameter, and the interlace index.
Aspect 38: The method of Aspect 37, wherein the UE is a participating UE associated with the coordinated access to the unlicensed spectrum, and the method further comprises: transmitting a coordination message that indicates a recommended resource in the unlicensed spectrum.
Aspect 39: The method of Aspect 38, wherein the coordination message indicates a start time associated with the recommended resource.
Aspect 40: The method of Aspect 38 or Aspect 39, wherein communicating in the wireless network comprises: communicating in the wireless network based at least in part on the recommended resource.
Aspect 41: The method of any one of Aspects 38-40, wherein the resource reservation associated with the unlicensed spectrum is based at least in part on the recommended resource.
Aspect 42: The method of any one of Aspects 37-41, wherein receiving the indication further comprises: transmitting the indication based at least in part on coordinated access reservation sidelink control information.
Aspect 43: The method of any one of Aspects 37-42, wherein the UE is a participating UE associated with the coordinated access to the unlicensed spectrum, and the method further comprises: receiving, from a coordinating UE associated with the coordinated access to the unlicensed spectrum, an assigned resource associated with the unlicensed spectrum, wherein the resource reservation indicates the assigned resource.
Aspect 44: The method of Aspect 43, wherein the resource is associated with a channel occupancy time structure.
Aspect 45: The method of any one of Aspects 37-44, wherein the UE is a participating UE associated with the coordinated access to the unlicensed spectrum, the indication of the resource reservation is a first indication, and the method further comprises: transmitting a second indication that specifies at least one of: a channel access request or a buffer status report.
Aspect 46: The method of Aspect 45, wherein transmitting the second indication further comprises: transmitting the channel access request or the buffer status report based at least in part on groupcast sidelink control information.
Aspect 47: The method of Aspect 45 or Aspect 46, wherein transmitting the second indication further comprises: transmitting the second indication periodically.
Aspect 48: The method of any one of Aspects 45-47, wherein transmitting the second indication further comprises: transmitting the second indication based at least in part on: a physical sidelink feedback channel, or a physical sidelink shared channel.
Aspect 49: The method of any one of Aspects 45-48, further comprising: determining a transmission resource based at least in part on: a groupcast identifier, a medium access control (MAC) control element (CE), or a second stage sidelink control information, wherein transmitting the second indication further comprises transmitting the second indication based at least in part on the transmission resource wherein transmitting the second indication further comprises transmitting the second indication based at least in part on the transmission resource.
Aspect 50: The method of Aspect 45, wherein transmitting the second indication further comprises: transmitting the second indication based at least in part on transmitting a scheduling request.
Aspect 51: The method of any one of Aspects 45-50, further comprising: receiving, as the first indication, coordinated access reservation sidelink control information that is based at least in part on the second indication.
Aspect 52: The method of Aspect 51, wherein the coordinated access reservation sidelink control information comprises at least one of: a reserved LBT window, a zone identifier associated with a coordinating UE, a range of coordination associated with the coordinating UE, or a maximum channel access priority class value associated with resource reservation capabilities.
Aspect 53: The method of Aspect 51 or Aspect 52, further comprising: determining whether to participate in the coordinated access to the unlicensed spectrum based at least in part on the coordinated access reservation sidelink control information. Aspect 54: The method of Aspect 53, further comprising: determining to refrain from participating in the coordinated access to the unlicensed spectrum, wherein communicating in the wireless network further comprises: refraining from transmitting in the wireless network based at least in part on the resource reservation associated with the unlicensed spectrum, the LBT parameter, and the interlace index.
Aspect 55: The method of Aspect 54, wherein determining to refrain from participating in the coordinated access further comprises: determining to refrain from participating in the coordinated access based at least in part on one of: a start time associated with the reserved LBT window failing to satisfy a packet delay budget associated with the UE, the zone identifier indicating that the coordinating UE is located at a position that fails to satisfy a distance threshold, the range of coordination associated with the coordinating UE failing to satisfy a range threshold, or the maximum channel access priority class value failing to satisfy a traffic channel access priority class threshold.
Aspect 56: The method of any one of Aspects 37-53, further comprising: determining to join the coordinated access to the unlicensed spectrum; and transmitting a channel access request based at least in part on the determining.
Aspect 57: The method of any one of Aspects 37-56, wherein the LBT parameter comprises at least one of: an LBT window associated with a start time and an end time for clearing LBT, a reserved channel occupancy time slot, an identifier of the UE, or an interlace index associated with a reserved resource for the UE.
Aspect 58: The method of Aspect 57, wherein the LBT parameter further comprises at least one of: a reserve gap between the end time for clearing the LBT and transmitting in a reserved resource, or a joint start LBT time for joint LBT by multiple UEs.
Aspect 59: The method of Aspect 57 or Aspect 58, wherein the LBT parameter further comprises at least one of: a backoff counter value, a starting transmission time associated with a Customer Premise Equipment, or a defer duration associated with joint LBT.
Aspect 60: The method of any one of Aspects 37-59, wherein the indication further indicates a set of UEs eligible to participate in the coordinated access to unlicensed spectrum.
Aspect 61: The method of any one of Aspects 37-60, wherein the indication of the resource reservation further indicates, for each UE in a set of UEs participating in the coordinated access to unlicensed spectrum, at least one of: an interlace index assigned to the UE in the set, one or more sub-bands assigned to the UE in the set, or an identifier of the UE in the set.
Aspect 62: An apparatus for wireless communication at a device, comprising a processor; memory coupled with the processor; and instructions stored in the memory and executable by the processor to cause the apparatus to perform the method of one or more of Aspects 1-36.
Aspect 63: An apparatus for wireless communication at a device, comprising a processor; memory coupled with the processor; and instructions stored in the memory and executable by the processor to cause the apparatus to perform the method of one or more of Aspects 37-61.
Aspect 64: A device for wireless communication, comprising a memory and one or more processors coupled to the memory, the one or more processors configured to perform the method of one or more of Aspects 1-36.
Aspect 65: A device for wireless communication, comprising a memory and one or more processors coupled to the memory, the one or more processors configured to perform the method of one or more of Aspects 37-61.
Aspect 66: An apparatus for wireless communication, comprising at least one means for performing the method of one or more of Aspects 1-36.
Aspect 67: An apparatus for wireless communication, comprising at least one means for performing the method of one or more of Aspects 37-61.
Aspect 68: A non-transitory computer-readable medium storing code for wireless communication, the code comprising instructions executable by a processor to perform the method of one or more of Aspects 1-36.
Aspect 69: A non-transitory computer-readable medium storing code for wireless communication, the code comprising instructions executable by a processor to perform the method of one or more of Aspects 37-61.
Aspect 70: A non-transitory computer-readable medium storing a set of instructions for wireless communication, the set of instructions comprising one or more instructions that, when executed by one or more processors of a device, cause the device to perform the method of one or more of Aspects 1-36.
Aspect 71: A non-transitory computer-readable medium storing a set of instructions for wireless communication, the set of instructions comprising one or more instructions that, when executed by one or more processors of a device, cause the device to perform the method of one or more of Aspects 37-61.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. An apparatus for wireless communication at a user equipment (UE), comprising:
a memory; and
one or more processors, coupled to the memory, configured to:
transmit an indication of a resource reservation associated with an unlicensed spectrum, the indication specifying at least a listen-before-talk (LBT) parameter associated with a channel access procedure for accessing the unlicensed spectrum and an interlace index associated with a resource in the unlicensed spectrum assigned to a participating UE associated with coordinated access to the unlicensed spectrum; and
communicate in a wireless network based at least in part on the resource reservation associated with the unlicensed spectrum, the LBT parameter, and the interlace index.

2. The apparatus of claim 1, wherein the one or more processors are further configured to:
receive, from the participating UE, a coordination message that indicates a recommended resource in the unlicensed spectrum.

3. The apparatus of claim 1, wherein the one or more processors, to transmit the indication, are configured to:
transmit the indication based at least in part on coordinated access reservation sidelink control information.

4. The apparatus of claim 1, wherein the one or more processors are further configured to:
assign a resource in the unlicensed spectrum to the participating UE, wherein the resource reservation indicates the resource.

5. The apparatus of claim 1, wherein the indication is a first indication, and wherein the one or more processors are further configured to:
receive, from the participating UE, a second indication that specifies at least one of: a channel access request or a buffer status report; and
calculate a number of resources in the unlicensed spectrum to reserve based at least in part on the second indication,
wherein the resource reservation is based at least in part on the calculated number of resources.

6. The apparatus of claim 5, wherein the one or more processors, to receive the second indication, are configured to recover the channel access request or the buffer status report from groupcast sidelink control information.

7. The apparatus of claim 6, wherein the one or more processors, to receive the second indication, are configured to:
receive the second indication based at least in part on:
a physical sidelink feedback channel, or
a physical sidelink shared channel.

8. The apparatus of claim 5, wherein the one or more processors are further configured to:
calculate the number of resources in unlicensed spectrum to reserve based at least in part on a location of the participating UE satisfying a distance threshold.

9. The apparatus of claim 5, wherein the one or more processors, to receive the second indication, are configured to:
receive the second indication based at least in part on receiving a scheduling request.

10. The apparatus of claim 5, wherein the one or more processors are further configured to:
determine a set of UEs based at least in part on receiving the second indication from the participating UE, wherein the set of UEs includes the participating UE,
wherein the one or more processors, to transmit the first indication, are configured to:
transmit the first indication to each UE in the set of UEs.

11. The apparatus of claim 10, wherein the one or more processors are further configured to:
determine to include the participating UE in the set of UEs based at least in part on identifying the second indication as a request to participate in the coordinated access to the unlicensed spectrum.

12. The apparatus of claim 5, wherein the one or more processors are further configured to:
transmit, as the first indication, coordinated access reservation sidelink control information that is based at least in part on the second indication.

13. The apparatus of claim 1, wherein the LBT parameter comprises at least one of:
an LBT window associated with a start time and an end time for clearing LBT, a reserved channel occupancy time slot,
an identifier of a participating UE associated with the coordinated access to the unlicensed spectrum, or
an interlace index associated with a reserved resource for the participating UE.

14. The apparatus of claim 1, wherein the indication of the resource reservation further indicates, for each UE in a set of UEs participating in the coordinated access to unlicensed spectrum, at least one of:
an interlace index assigned to the UE in the set,
one or more sub-bands assigned to the UE in the set, or
an identifier of the UE in the set.

15. The apparatus of claim 1, wherein the one or more processors are further configured to:
fail to receive, prior to transmitting the indication of the resource reservation associated with unlicensed spectrum, valid coordinated access reservation sidelink control information from a number of coordinating UEs that satisfies a count threshold; and
determine to act as a coordinating UE for coordinated access to the unlicensed spectrum based at least in part on the number failing to satisfy the count threshold.

16. An apparatus for wireless communication at a user equipment (UE), comprising:
a memory; and
one or more processors, coupled to the memory, configured to:
receive an indication of a resource reservation associated with an unlicensed spectrum, the indication specifying at least a listen-before-talk (LBT) parameter associated with a channel access procedure for accessing the unlicensed spectrum and an interlace index associated with a resource in the unlicensed spectrum assigned to the UE, the indication associated with coordinated access to the unlicensed spectrum; and
communicate in a wireless network based at least in part on the resource reservation associated with the unlicensed spectrum, the LBT parameter, and the interlace index.

17. The apparatus of claim 16, wherein the one or more processors are further configured to:
transmit a coordination message that indicates a recommended resource in the unlicensed spectrum.

18. The apparatus of claim 16 wherein the one or more processors are further configured to:
receive, from a coordinating UE associated with the coordinated access to the unlicensed spectrum, an assigned resource associated with the unlicensed spectrum, wherein the resource reservation indicates the assigned resource.

19. The apparatus of claim 16, wherein the indication is a first indication, and wherein the one or more processors are further configured to:
transmit a second indication that specifies at least one of: a channel access request or a buffer status report.

20. The apparatus of claim 19, wherein the one or more processors are further configured to:
determine a transmission resource based at least in part on:
a groupcast identifier,
a medium access control (MAC) control element (CE), or
a second stage sidelink control information,
wherein the one or more processors, to transmit the second indication, are configured to transmit the second indication based at least in part on the transmission resource.

21. The apparatus of claim 19, wherein the one or more processors are further configured to:
receive, as the first indication, coordinated access reservation sidelink control information that is based at least in part on the second indication.

22. The apparatus of claim 21, wherein the coordinated access reservation sidelink control information comprises at least one of:
a reserved LBT window,
a zone identifier associated with a coordinating UE,
a range of coordination associated with the coordinating UE, or
a maximum channel access priority class value associated with resource reservation capabilities.

23. The apparatus of claim 21, wherein the one or more processors are further configured to:
determine whether to participate in the coordinated access to the unlicensed spectrum based at least in part on the coordinated access reservation sidelink control information.

24. The apparatus of claim 23, wherein the one or more processors are further configured to:
determine to refrain from participating in the coordinated access to the unlicensed spectrum,
wherein the one or more processors, to communicate in the wireless network, are configured to:
refrain from transmitting in the wireless network based at least in part on the resource reservation associated with the unlicensed spectrum, the LBT parameter, and the interlace index.

25. The apparatus of claim 16, wherein the one or more processors are further configured to:
determine to join the coordinated access to the unlicensed spectrum; and
transmit a channel access request based at least in part on determining to join the coordinated access.

26. The apparatus of claim 16, wherein the indication of the resource reservation further indicates, for each UE in a set of UEs participating in the coordinated access to unlicensed spectrum, at least one of:
an interlace index assigned to the UE in the set,
one or more sub-bands assigned to the UE in the set, or
an identifier of the UE in the set.

27. A method of wireless communication performed by a user equipment (UE), comprising:
transmitting an indication of a resource reservation associated with an unlicensed spectrum, the indication specifying at least a listen-before-talk (LBT) parameter associated with a channel access procedure for accessing the unlicensed spectrum and an interlace index associated with a resource in the unlicensed spectrum assigned to a participating UE associated with coordinated access to the unlicensed spectrum; and
communicating in a wireless network based at least in part on the resource reservation associated with the unlicensed spectrum, the LBT parameter, and the interlace index.

28. The method of claim 27, wherein the indication of the resource reservation further indicates, for each UE in a set of UEs participating in the coordinated access to unlicensed spectrum, at least one of:
an interlace index assigned to the UE in the set,
one or more sub-bands assigned to the UE in the set, or
an identifier of the UE in the set.

29. A method of wireless communication performed by a user equipment (UE), comprising:
receiving an indication of a resource reservation associated with an unlicensed spectrum, the indication specifying at least a listen-before-talk (LBT) parameter associated with a channel access procedure for accessing the unlicensed spectrum and an interlace index associated with a resource in the unlicensed spectrum assigned to the UE, the indication associated with coordinated access to the unlicensed spectrum; and
communicating in a wireless network based at least in part on the resource reservation associated with the unlicensed spectrum, the LBT parameter, and the interlace index.

30. The method of claim 29, wherein communicating in the wireless network comprises:
communicating in the wireless network based at least in part on the indication of the resource reservation.
